(19) United States
(12) Patent Application Publication
(10) Pub. No.: US 2026/0045959 A1
(43) Pub. Date: Feb. 12, 2026

(54) RADIO FREQUENCY CIRCUIT

(71) Applicant: Murata Manufacturing Co., Ltd., Nagaokakyo-shi (JP)

(72) Inventors: Hirotsugu MORI, Nagaokakyo-shi (JP); Morio TAKEUCHI, Nagaokakyo-shi (JP)

(73) Assignee: Murata Manufacturing Co., Ltd., Nagaokakyo-shi (JP)

(21) Appl. No.: 19/365,322

(22) Filed: Oct. 22, 2025

Related U.S. Application Data
(63) Continuation of application No. PCT/JP2024/009478, filed on Mar. 12, 2024.

(30) Foreign Application Priority Data
Apr. 24, 2023 (JP) 2023-071136

(51) Int. Cl. H04B 1/00

(52) U.S. Cl. CPC H04B 1/006; H04B 1/0003

(57) ABSTRACT

A radio frequency circuit includes: first and second power amplifiers; a low-noise amplifier; first and second switches; a first filter for a first band; a second filter for a second band; and third and fourth filters for a third band for time division duplex. Triple beat distortion that occurs due to two signals in the first band and a signal in the second band overlaps the third band. The first filter is connected between the first power amplifier and the second switch, the second power amplifier is connected to the first switch, the second filter is connected between the first and second switches, the third filter is connected between the first and second switches, and the fourth filter is connected between the low-noise amplifier and the second switch.

### CROSS-REFERENCE TO RELATED APPLICATIONS

This is a continuation application of PCT International Application No. PCT/JP2024/009478 filed on Mar. 12, 2024, designating the United States of America, which is based on and claims priority of Japanese Patent Application No. 2023-071136 filed on Apr. 24, 2023. The entire disclosures of the above-identified applications, including the specifications, drawings, and claims are incorporated herein by reference in their entirety.

### TECHNICAL FIELD

The present disclosure relates to a radio frequency circuit.

### BACKGROUND

In 5th Generation New Radio (5G NR), a band having a wider bandwidth can be used, and efficient use of such wide bands has been examined. For example, depending on a country or a region, it has been examined to divide a wide band into sub-bands and assign the divided sub-bands to different mobile network operators (MNOs). Furthermore, it has also been examined to perform communication by simultaneously using discontinuous component carriers (CCs) within a wide first band (Intra-band Non-contiguous Carrier Aggregation). (U.S. Patent Application Publication No. 2014/0111178)

### SUMMARY

### Technical Problems

However, as recognized by the present inventor, triple beat distortion may occur in a case in which two CCs in the first band and one CC in a second band are simultaneously transferred. In a case in which a frequency of such a triple beat distortion component overlaps the receiving band and the distortion component enters the reception path, the reception sensitivity deteriorates, which is a problem.

In view of this, the present disclosure provides a radio frequency circuit having reduced deterioration of reception sensitivity in a case in which three signals in two bands are simultaneously transferred.

### Solutions

A radio frequency circuit according to an aspect of the present disclosure includes: a first power amplifier; a second power amplifier; a first low-noise amplifier; a first switch; a second switch; a first filter having a passband that includes at least a portion of a first band; a second filter having a passband that includes at least a portion of a second band; a third filter having a passband that includes a third band for time division duplex; and a fourth filter having a passband that includes the third band. A frequency obtained by subtracting a frequency of one signal from a sum of frequencies of two signals overlaps the third band, the two signals being randomly selected from among two signals having different frequencies in the first band and a signal having a frequency in the second band, the one signal being a remaining signal, the first filter is connected between the first power amplifier and the second switch, the second power amplifier is connected to the first switch, the second filter is connected between the first switch and the second switch, the third filter is connected between the first switch and the second switch, and the fourth filter is connected between the first low-noise amplifier and the second switch.

A radio frequency circuit according to an aspect of the present disclosure includes: a first power amplifier; a second power amplifier; a third power amplifier; a fourth power amplifier; a first low-noise amplifier; a second low-noise amplifier; a first switch; a second switch; a third switch; a fourth switch; a first filter having a passband that includes Band B40 for 4th Generation Long Term Evolution (4G LTE) or Band n40 for 5th Generation New Radio (5G NR); a second filter having a passband that includes Band B41 for 4G LTE or Band n41 for 5G NR; a third filter having a passband that includes an uplink operating band of Band B1 for 4G LTE or Band n1 for 5G NR; a fourth filter having a passband that includes an uplink operating band of Band B3 for 4G LTE or Band n3 for 5G NR; a fifth filter having a passband that includes Band B39 for 4G LTE or Band n39 for 5G NR; a sixth filter having a passband that includes Band B34 for 4G LTE or Band n34 for 5G NR; a seventh filter having a passband that includes Band B39 for 4G LTE or Band n39 for 5G NR; and an eighth filter having a passband that includes Band B34 for 4G LTE or Band n34 for 5G NR. The first filter is connected between the first power amplifier and the second switch, the second filter is connected between the second power amplifier and the second switch, the third power amplifier is connected to the first switch, the third filter is connected between the first switch and the second switch, the fourth power amplifier is connected to the first switch, the fourth filter is connected between the first switch and the second switch, the fifth filter is connected between the first switch and the second switch, the sixth filter is connected between the first switch and the second switch, the seventh filter is connected between the first low-noise amplifier and the third switch, the eighth filter is connected between the second low-noise amplifier and the third switch, the second switch is connected between (i) the fourth switch and (ii) the first filter, the second filter, the third filter, the fourth filter, the fifth filter, and the sixth filter, and the third switch is connected between (i) the fourth switch and (ii) the seventh filter and the eighth filter.

A radio frequency circuit according to an aspect of the present disclosure includes: a first power amplifier; a second power amplifier; a first low-noise amplifier; a first switch; a second switch; a first filter having a passband that includes at least a portion of a first band; a second filter having a passband that includes at least a portion of a second band; a third filter having a passband that includes a third band for time division duplex; and a fourth filter having a passband that includes the third band. A frequency obtained by subtracting a frequency of one signal from a sum of frequencies of two signals overlaps the third band, the two signals being randomly selected from among two signals having different frequencies in the second band and a signal having a frequency in the first band, the one signal being a remaining signal, the first filter is connected between the first power amplifier and the second switch, the second power amplifier is connected to the first switch, the second filter is connected between the first switch and the second switch, the third filter is connected between the first switch and the second switch, and the fourth filter is connected between the first low-noise amplifier and the second switch.

### Advantageous Effects

According to the present disclosure, a radio frequency circuit having reduced deterioration of reception sensitivity in a case in which three signals in two bands are simultaneously transferred can be provided.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 illustrates a circuit configuration of a radio frequency circuit and a communication device according to an embodiment.

FIG. 2A illustrates a circuit configuration showing a signal transfer state of a radio frequency circuit according to Example 1.

FIG. 2B illustrates an example in which triple beat distortion occurs in the radio frequency circuit according to Example 1.

FIG. 3A illustrates a circuit configuration showing a signal transfer state of a radio frequency circuit according to Example 2.

FIG. 3B illustrates an example in which triple beat distortion occurs in the radio frequency circuit according to Example 2.

FIG. 4A illustrates a circuit configuration showing a signal transfer state of a radio frequency circuit according to Example 3.

FIG. 4B illustrates an example in which triple beat distortion occurs in the radio frequency circuit according to Example 3.

FIG. 5A illustrates a circuit configuration showing a signal transfer state of a radio frequency circuit according to Comparative Example 1.

FIG. 5B illustrates a circuit configuration showing a signal transfer state of a radio frequency circuit according to Comparative Example 2.

FIG. 6A illustrates a circuit configuration showing a first signal transfer state of a radio frequency circuit according to Example 4.

FIG. 6B illustrates a circuit configuration showing a second signal transfer state of the radio frequency circuit according to Example 4.

FIG. 6C illustrates a circuit configuration showing a third signal transfer state of the radio frequency circuit according to Example 4.

FIG. 7 illustrates a circuit configuration showing a signal transfer state of a radio frequency circuit according to Example 5.

FIG. 8 illustrates a circuit configuration showing a signal transfer state of a radio frequency circuit according to Example 6.

### DESCRIPTION OF EMBODIMENTS

The following describes in detail embodiments of the present disclosure with reference to the drawings. Note that the embodiments described below each show a general or specific example. The numerical values, shapes, materials, elements, and the arrangement and connection of the elements, for instance, described in the following embodiments are examples, and thus are not intended to limit the present disclosure.

Note that the drawings are schematic diagrams to which emphasis, omission, and ratio adjustment are appropriately added in order to illustrate the present disclosure, and thus are not necessarily accurate illustrations. The drawings may show shapes, positional relations, and ratios that are different from actual shapes, actual positional relations, and actual ratios. Throughout the drawings, the same numeral is given to substantially the same element, and redundant description may be omitted or simplified.

In the present disclosure, terms that indicate relations between elements such as parallel and perpendicular, a term that indicates the shape of an element such as rectangular, and a numerical range do not necessarily have only strict meanings, and also cover substantially equivalent ranges that include a difference of about several percent, for example.

In the present disclosure, “being connected” has a meaning including not only the case of being directly connected by a connection terminal and/or a line conductor, but also the case of being electrically connected via another circuit element. The expression “connected between A and B” means being connected between A and B on a path that connects A and B.

In the present disclosure, a “transmission path” means a transfer route that includes, for instance, a line through which a radio frequency transmission signal propagates, an electrode directly connected to the line, and a terminal directly connected to the line or the electrode. Furthermore, a “reception path” means a transfer route that includes, for instance, a line through which a radio frequency reception signal propagates, an electrode directly connected to the line, and a terminal directly connected to the line or the electrode.

In the present disclosure, a first band, a second band, and a third band mean frequency bands defined in advance by, for instance, a standardizing body (such as the 3rd Generation Partnership Project (3GPP (a registered trademark)) or the Institute of Electrical and Electronics Engineers (IEEE), for example), for a communication system established using radio access technology (RAT). In the present embodiment and Examples, as a communication system, for example, a Long Term Evolution (LTE) system, a 5th Generation (5G)—New Radio (NR) system, or a Wireless Local Area Network (WLAN) system, for instance, can be used as a communication system, but the communication system is not limited thereto.

An uplink operating band means a frequency band designated for uplink within the above-stated bands. A downlink operating band means a frequency band designated for downlink within the above-stated bands.

### Embodiment

### [1 Circuit Configuration of Radio Frequency Circuit 1 and Communication Device 5]

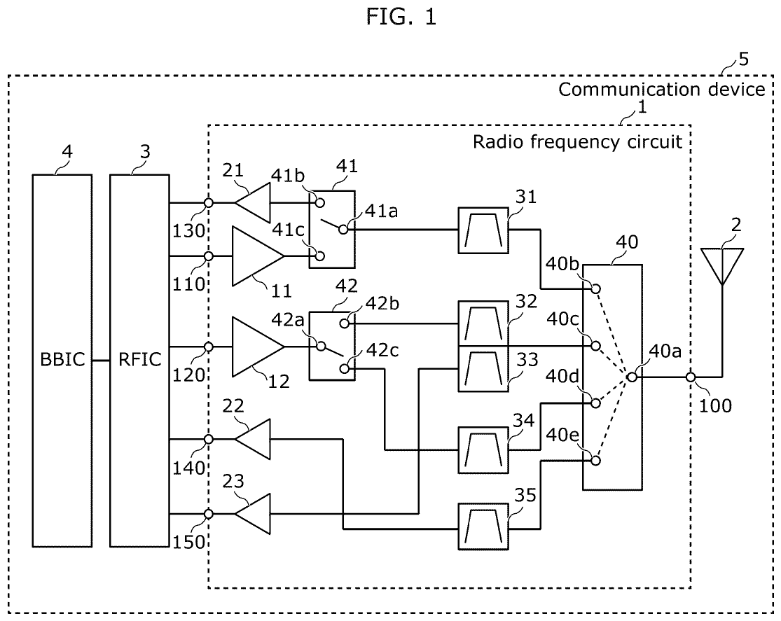

A circuit configuration of radio frequency circuit 1 and communication device 5 according to the present embodiment is described with reference to FIG. 1. FIG. 1 illustrates a circuit configuration of radio frequency circuit 1 and communication device according to an exemplary embodiment.

### [1.1 Circuit Configuration of Communication Device 5]

First, a circuit configuration of communication device 5 is described. As illustrated in FIG. 1, communication device 5 according to the present embodiment includes radio frequency circuit 1, antenna 2, radio frequency (RF) signal processing circuit (RF integrated circuit (IC)) 3, and base band signal processing circuit (BBIC) 4.

Radio frequency circuit 1 transfers radio frequency signals between antenna 2 and RFIC 3. A detailed circuit configuration of radio frequency circuit 1 is described later.

Antenna 2 is connected to antenna connection terminal 100 of radio frequency circuit 1, transmits radio frequency signals output from radio frequency circuit 1, and receives external radio frequency signals and outputs the signals to radio frequency circuit 1.

RFIC 3 is an example of a signal processing circuit that processes radio frequency signals. Specifically, RFIC 3 processes reception signals input through a reception path of radio frequency circuit 1 by down-conversion, for instance, and outputs to BBIC 4 reception signals generated by processing the input signals. Furthermore, RFIC 3 processes transmission signals input from BBIC 4 by up-conversion, for instance, and outputs transmission signals generated by processing the input signals to a transmission path of radio frequency circuit 1. RFIC 3 includes a controller that controls, for instance, switches and amplifiers that are included in radio frequency circuit 1. Note that part of or the entire functionality of RFIC 3 as a controller may be provided outside of RFIC 3, and thus may be provided in BBIC 4 or radio frequency circuit 1, for example.

BBIC 4 is a base band signal processing circuit that processes signals using an intermediate frequency band lower than a frequency of a radio frequency signal transferred by radio frequency circuit 1. A signal processed by BBIC 4 is used, for example, as an image signal for image display or as an audio signal for talk through a loudspeaker.

Note that antenna 2 and BBIC 4 are not essential elements of communication device 5 according to the present embodiment.

### [1.2 Circuit Configuration of Radio Frequency Circuit 1]

Next, a circuit configuration of radio frequency circuit 1 is described. As illustrated in FIG. 1, radio frequency circuit 1 includes power amplifiers 11 and 12, low-noise amplifiers 21, 22, and 23, switches 40, 41, and 42, filters 31, 32, 33, 34, and 35, antenna connection terminal 100, radio frequency input terminals 110 and 120, and radio frequency output terminals 130, 140, and 150.

Antenna connection terminal 100 is connected to antenna 2 and switch 40.

Power amplifier 11 is an example of a first power amplifier, and can amplify radio frequency transmission signals (hereinafter, referred to as transmission signals) in a first band output from RFIC 3. The input end of power amplifier 11 is connected to RFIC 3 via radio frequency input terminal 110, and the output end of power amplifier 11 is connected to switch 41.

Power amplifier 12 is an example of a second power amplifier, and can amplify transmission signals in a second band and a third band output from RFIC 3. The input end of power amplifier 12 is connected to RFIC 3 via radio frequency input terminal 120, and the output end of power amplifier 12 is connected to switch 42.

Low-noise amplifier 21 amplifies radio frequency reception signals (hereinafter, referred to as reception signals) in the first band input via antenna connection terminal 100. The input end of low-noise amplifier 21 is connected to switch 41, and the output end of low-noise amplifier 21 is connected to RFIC 3 via radio frequency output terminal 130.

Low-noise amplifier 22 is an example of a first low-noise amplifier, and amplifies reception signals in the third band input via antenna connection terminal 100. The input end of low-noise amplifier 22 is connected to filter 35, and the output end of low-noise amplifier 22 is connected to RFIC 3 via radio frequency output terminal 140.

Low-noise amplifier 23 is an example of a second low-noise amplifier, and amplifies reception signals in the second band input via antenna connection terminal 100. The input end of low-noise amplifier 23 is connected to filter 33, and the output end of low-noise amplifier 23 is connected to RFIC 3 via radio frequency output terminal 150.

Switch 40 is an example of a second switch, includes terminals 40a (antenna terminal), 40b (first selection terminal), 40c (second selection terminal), 40d (third selection terminal), and 40e (fourth selection terminal), and switches connection between terminal 40a and at least one of terminal 40b, 40c, 40d, or 40e. Terminal 40a is connected to antenna 2 via antenna connection terminal 100. Terminal 40b is connected to one end of filter 31. Terminal 40c is connected to the output end of filter 32 and the input end of filter 33. Terminal 40d is connected to the output end of filter 34. Terminal 40e is connected to the input end of filter 35.

Switch 41 includes terminals 41a, 41b, and 41c, and selectively switches connection of terminal 41a between terminals 41b and 41c. Switch 41 is a time division duplex (TDD) switch that switches between transmission and reception in the first band.

Switch 42 is an example of a first switch, includes terminals 42a (first terminal), 42b (second terminal), and 42c (third terminal), and selectively switches connection of terminal 42a between terminals 42b and 42c. Terminal 42a is connected to the output end of power amplifier 12, terminal 42b is connected to filter 32, and terminal 42c is connected to filter 34. Switch 42 selectively switches between transmission in the second band and transmission in the third band.

Filter 31 is an example of a first filter, and has a passband that includes at least a portion of the first band. Filter 31 is connected between power amplifier 11 and switch 40. Specifically, one end of filter 31 is connected to terminal 40b, and the other end of filter 31 is connected to power amplifier 11 or low-noise amplifier 21 via terminal 41a.

Note that the first band is a TDD band, but may be a frequency division duplex (FDD) band. Under a condition that the first band is an FDD band, a filter for transmission in the first band is connected between terminal 40b and power amplifier 11 and a filter for reception in the first band is connected between terminal 40b and low-noise amplifier 21, instead of filter 31.

Filter 32 is an example of a second filter, and has a passband that includes at least a portion of the second band. Filter 32 is connected between switch 42 and switch 40. Specifically, filter 32 has a passband that includes an uplink operating band of the second band. The input end of filter 32 is connected to terminal 42b, and the output end of filter 32 is connected to terminal 40c.

Filter 33 is an example of a fifth filter, and has a passband that includes a downlink operating band of the second band. Filter 33 is connected between low-noise amplifier 23 and switch 40.

Note that the second is an FDD band, but may be a TDD band. Under a condition that the second band is a TDD band, instead of filters 32 and 33, a TDD filter having a passband that includes the second band and a switch that switches between transmission and reception are connected between (i) switch 40 and (ii) switch 42 and low-noise amplifier 23.

Filter 34 is an example of a third filter, and has a passband that includes the third band for TDD. Filter 34 is connected between switch 42 and switch 40. Specifically, the input end of filter 34 is connected to terminal 42c, and the output end of filter 34 is connected to terminal 40d. Filter 34 is a transmission filter that passes transmission signals in the third band.

Filter 35 is an example of a fourth filter, and has a passband that includes the third band for TDD. Filter 35 is connected between low-noise amplifier 22 and switch 40. Specifically, the input end of filter 35 is connected to terminal 40e, and the output end of filter 35 is connected to the input end of low-noise amplifier 22. Filter 35 is a reception filter that passes reception signals in the third band. Filter 35 is connected directly to low-noise amplifier 22, not through switch 42. This arrangement maximizes isolation by preventing distortion signals present at the output of power amplifier 12 from coupling directly into the reception path of the third band via switch 42.

Radio frequency circuit 1 according to the present embodiment has a configuration in which single power amplifier 12 amplifies both a transmission signal in the second band and a transmission signal in the third band. Accordingly, the size of radio frequency circuit 1 can be decreased. On the other hand, as a filter that passes signals in the third band for TDD, filter 34 for transmission and filter 35 for reception are disposed. As a configuration that passes signals in the third band for TDD, a configuration that includes a single filter for both transmission and reception and a TDD switch is not adopted.

According to this, signals output from power amplifier 12 can be prevented from sneaking into a reception path for the third band via the TDD switch.

Note that filter 34 for transmission and filter 35 for reception may have different structures or different properties. For example, filter 34 may have a structure that focuses on low loss in the passband, and filter 35 may have a structure that focuses on the attenuation in the attenuation band. According to this, the third band is applicable to a band that can support Power Class 2 that is a high-power class. Note that a power class is a classification of output power of user equipment (UE) defined based on, for instance, a maximum output power, and a smaller value of a power class indicates that a higher output power is allowed. For example, according to the 3GPP (registered trademark), the maximum output power allowed in Power Class 1 is 31 dBm, the maximum output power allowed in Power Class 1.5 is 29 dBm, and the maximum output power allowed in Power Class 2 is 26 dBm, and the maximum output power allowed in Power Class 3 is 23 dBm.

According to the above configuration of radio frequency circuit 1 according to the present embodiment, two transmission signals in the first band (two CCs) and one transmission signal in the second band can be simultaneously transmitted. Here, the frequencies of two transmission signals in the first band are denoted by f1 and f2, and the frequency of a transmission signal in the second band is denote by f3, what is called triple beat distortion occurs in power amplifiers 11 and 12 in simultaneous transmission of the above three transmission signals. In particular, triple beat primary distortion has high intensity and occurs at frequencies (±f1±f2±f3), and primary distortion having frequencies (f1−f2+f3, f1+f2−f3, and −f1+f2+f3) among the above frequencies occurs in vicinity of the first band or the second band. Stated differently, frequencies (f1−f2+f3, f1+f2−f3, and −f1+f2+f3) are obtained by subtracting a frequency of a remaining signal from frequencies of two signals randomly selected from among two signals having different frequencies f1 and f2 in the first band and a signal having frequency f3 in the second band.

In such a frequency relation, frequencies at which triple beat primary distortion (frequencies f1−f2+f3, f1+f2−f3, and −f1+f2+f3) occurs at least partially overlap the receiving band of the third band, the primary distortion component propagates through the transmission path for the first band and/or the transmission path for the second band and the reception path for the third band, and if the component enters low-noise amplifier 22, the reception sensitivity for the third band deteriorates, which is a problem.

To address this, according to radio frequency circuit 1 according to the present embodiment, even in a case in which triple beat distortion occurs in power amplifier 11 and/or power amplifier 12 in simultaneous transmission of two transmission signals in the first band and one transmission signal in the second band, (1) the output ends of power amplifiers 11 and 12 and the input end of low-noise amplifier 22 are not directly connected by switches, (2) the primary distortion component generated in power amplifier 11 is sufficiently attenuated by filter 31, and (3) the primary distortion component generated in power amplifier 12 is sufficiently attenuated by filter 32. If the primary distortion component generated by the amplifiers is sufficiently strong, it can leak or couple from the transmission paths into the reception path for the third band, so sufficient attenuation thereof can ensure high isolation between low-noise amplifier 22 and power amplifiers 11 and 12. Thus, deterioration of reception sensitivity in a case in which three transmission signals in two bands are simultaneously transferred can be reduced.

### [1.3 Circuit Configuration of Radio Frequency Circuit 1A According to Example 1]

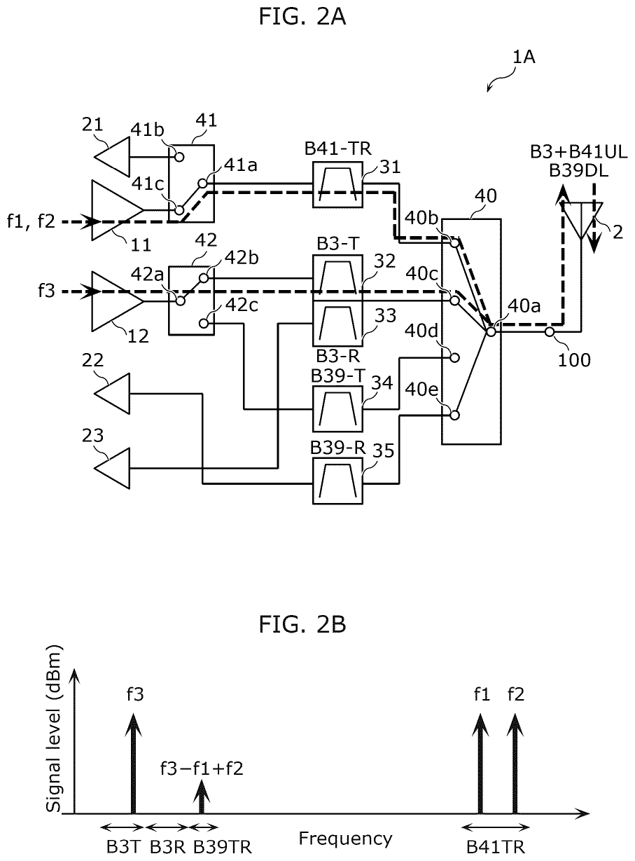

FIG. 2A illustrates a circuit configuration of radio frequency circuit 1A according to Example 1. As illustrated in the drawing, radio frequency circuit 1A according to Example 1 has the same circuit configuration as that of radio frequency circuit 1 according to the embodiment, and specific bands are applied to the first band to the third band. In the following, description of the same features of radio frequency circuit 1A according to this example as those of radio frequency circuit 1 according to the embodiment is omitted, and differences therefrom are mainly described.

In radio frequency circuit 1A according to this example, the first band is a TDD band such as Band B41 (2496 MHz to 2690 MHZ) for 4G LTE or Band n41 (2496 MHz to 2690 MHZ) for 5G NR, for example. The second band is an FDD band such as Band B3 for 4G LTE (uplink operating band: 1710 MHz to 1785 MHZ, downlink operating band: 1805 MHz to 1880 MHZ) or Band n3 for 5G NR (uplink operating band: 1710 MHz to 1785 MHZ, downlink operating band: 1805 MHz to 1880 MHZ). The third band is a TDD band such as Band B39 (1880 MHz to 1920 MHz) for 4G LTE or Band n39 (1880 MHz to 1920 MHZ) for 5G NR, for example.

Hereinafter, in a case in which the bands are stated, Band B41 for 4G LTE or Band n41 for 5G NR may be simplified and stated just as Band B41.

In radio frequency circuit 1A, a mode of simultaneously transmitting two transmission signals in Band B41 (having frequencies f1 and f2) and one transmission signal in Band B3 (having frequency f3) and at the same time, receiving a reception signal in Band B39 and a reception signal in Band B3 (B3+B41UL+B39DL) is executed.

In this case, the two transmission signals in Band B41 are output to antenna 2 via power amplifier 11, switch 41, filter 31, and switch 40. The one transmission signal in Band B3 is output to antenna 2 via power amplifier 12, switch 42, filter 32, and switch 40.

A reception signal in Band B39 is output to RFIC 3 via antenna 2, switch 40, filter 35, and low-noise amplifier 22. A reception signal in Band B3 is output to RFIC 3 via antenna 2, switch 40, filter 33, and low-noise amplifier 23.

FIG. 2B illustrates an example in which triple beat distortion occurs in radio frequency circuit 1A according to Example 1. This drawing illustrates a relation between frequencies of signals that occur in radio frequency circuit 1A and signal levels thereof. Specifically, the drawing illustrates spectra of (1) two transmission signals (frequencies f1 and f2) in Band B41 output from power amplifier 11, (2) one transmission signal (frequency f3) in Band B3 output from power amplifier 12, and (3) triple beat distortion (frequency f3−f1+f2) that occurs due to two transmission signals in Band B41 and one transmission signal in Band B3.

In this example, the first band (Band B41) is in a frequency range higher than a frequency range of the second band (Band B3).

In the above configuration, two transmission signals in Band B41 are two component carriers (CCs) within the same band, and thus triple beat primary distortions (frequencies f3−f1+f2 and f3+f1−f2) occur in the vicinity of Band B3. Here, one (frequency f3−f1+f2) of the triple beat primary distortions occurs in the vicinity of the frequency range higher than Band B3, and overlaps Band B39 received simultaneously with transmission of three transmission signals in Band B41 and Band B3.

To address this, according to radio frequency circuit 1A according to this example, even in a case in which triple beat distortion occurs in power amplifier 11 and/or power amplifier 12 in simultaneous transmission of two transmission signals in Band B41 for TDD and one transmission signal in Band B3 for FDD, (1) the output ends of power amplifiers 11 and 12 and the input end of low-noise amplifier 22 are not directly connected by switches, (2) the primary distortion component generated in power amplifier 11 is sufficiently attenuated by filter 31, and (3) the primary distortion component generated in power amplifier 12 is sufficiently attenuated by filter 32. Accordingly, high isolation can be ensured between low-noise amplifier 22 and power amplifiers 11 and 12, and thus deterioration of reception sensitivity in Band B39 in a case in which three transmission signals in Bands B41 and B3 are simultaneously transferred can be reduced.

Note that radio frequency circuit 1 according to the present embodiment may include power amplifiers 11 and 12, low-noise amplifier 22, switches 40 and 42, and filters 31, 32, 34, and 35, but low-noise amplifiers 21 and 23, switch 41, filter 33, antenna connection terminal 100, radio frequency input terminals 110 and 120, and radio frequency output terminals 130, 140, and 150 are not essential elements.

### [1.4 Circuit Configuration of Radio Frequency Circuit 1B According to Example 2]

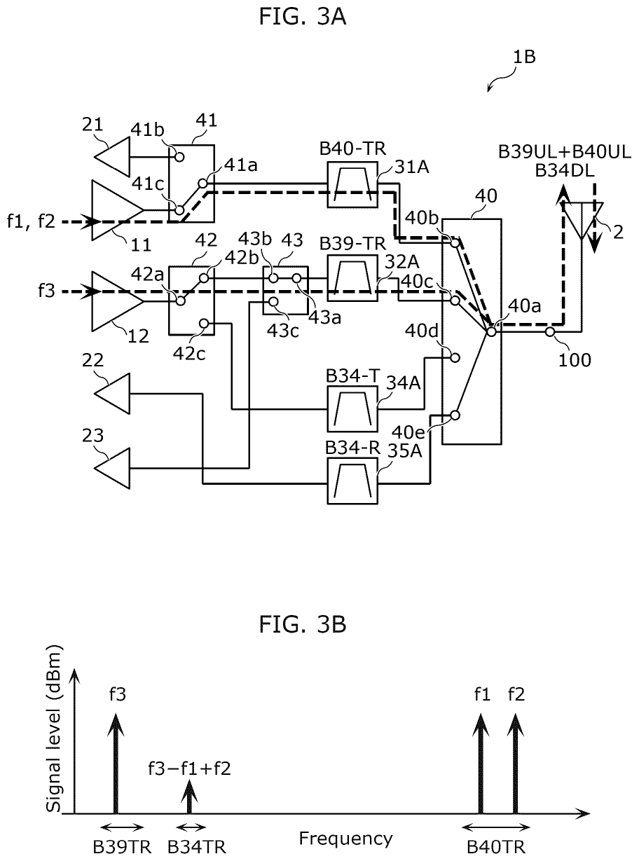

FIG. 3A illustrates a circuit configuration of radio frequency circuit 1B according to Example 2. As illustrated in the drawing, radio frequency circuit 1B includes power amplifiers 11 and 12, low-noise amplifiers 21, 22, and 23, switches 40, 41, 42, and 43, filters 31A, 32A, 34A, and 35A, and antenna connection terminal 100. Radio frequency circuit 1B according to this example is different from radio frequency circuit 1 according to the embodiment in a circuit configuration of a path for transferring signals in the second band. In the following, description of the same features of radio frequency circuit 1B according to this example as those of radio frequency circuit 1 according to the embodiment is omitted, and differences therefrom are mainly described.

Switch 40 is an example of a second switch, and has the same configuration as that of switch 40 according to the embodiment. Terminal 40a is connected to antenna 2 via antenna connection terminal 100. Terminal 40b is connected to one end of filter 31A. Terminal 40c is connected to one end of filter 32A. Terminal 40d is connected to the output end of filter 34A. Terminal 40e is connected to the input end of filter 35A.

Switch 41 has the same configuration as that of switch 41 according to the embodiment. Switch 41 is a TDD switch that switches between transmission and reception in the first band.

Switch 42 has the same configuration as that of switch 42 according to the embodiment. Terminal 42a is connected to the output end of power amplifier 12, terminal 42b is connected to terminal 43b of switch 43, and terminal 42c is connected to filter 34A. Switch 42 selectively switches between transmission in the second band and transmission in the third band.

Switch 43 is an example of a third switch, includes terminals 43a, 43b, and 43c, and selectively switches connection of terminal 43a between terminals 43b and 43c. Switch 43 is a TDD switch that switches between transmission and reception in the second band.

Filter 31A is an example of a first filter, and has a passband that includes at least a portion of the first band. Filter 31A has the same connection configuration as that of filter 31 according to the embodiment.

Filter 32A is an example of a second filter, and has a passband that includes at least a portion of the second band. Filter 32A is connected between switch 42 and switch 40. Specifically, filter 32A has a passband that includes the second band. One end of filter 32A is connected to terminal 40c, and the other terminal of filter 32A is connected to terminal 43a of switch 43.

Filter 34A is an example of a third filter, and has a passband that includes the third band for TDD. Filter 34A is connected between switch 42 and switch 40. Specifically, the input end of filter 34A is connected to terminal 42c, and the output end of filter 34A is connected to terminal 40d. Filter 34A is a transmission filter that passes transmission signals in the third band.

Filter 35A is an example of a fourth filter, and has a passband that includes the third band for TDD. Filter 35A is connected between low-noise amplifier 22 and switch 40. Specifically, the input end of filter 35A is connected to terminal 40e, and the output end of filter 35A is connected to the input end of low-noise amplifier 22. Filter 35A is a reception filter that passes reception signals in the third band. Filter 35A is connected directly to low-noise amplifier 22, not through switch 42.

Radio frequency circuit 1B according to this example has a configuration in which single power amplifier 12 amplifies both a transmission signal in the second band and a transmission signal in the third band. Accordingly, the size of radio frequency circuit 1B can be decreased. On the other hand, as a filter that passes signals in the third band for TDD, filter 34A for transmission and filter 35A for reception are disposed. As a configuration that passes signals in the third band for TDD, a configuration that includes a single filter for both transmission and reception and a TDD switch is not adopted.

According to this, signals output from power amplifier 12 can be prevented from sneaking into a reception path for the third band via the TDD switch.

In radio frequency circuit 1B according to this example, the first band is a TDD band such as Band B40 (2300 MHZ to 2400 MHZ) for 4G LTE or Band n40 (2300 MHz to 2400 MHz) for 5G NR, for example. The second band is a TDD band such as Band B39 for 4G LTE or Band n39 for 5G NR, for example. The third band is a TDD band such as Band B34 (2010 MHz to 2025 MHZ) for 4G LTE or Band n34 (2010 MHZ to 2025 MHZ) for 5G NR, for example.

In radio frequency circuit 1B, a mode of simultaneously transmitting two transmission signals in Band B40 (having frequencies f1 and f2) and one transmission signal in Band B39 (having frequency f3), and at the same time, receiving a reception signal in Band B34 (B39UL+B40UL+B34DL) is executed.

In this case, two transmission signals in Band B40 are output to antenna 2 via power amplifier 11, switch 41, filter 31A, and switch 40. One transmission signal in Band B39 is output to antenna 2 via power amplifier 12, switch 42, switch 43, filter 32A, and switch 40.

A reception signal in Band B34 is output to RFIC 3 via antenna 2, switch 40, filter 35A, and low-noise amplifier 22.

FIG. 3B illustrates an example in which triple beat distortion occurs in radio frequency circuit 1B according to Example 2. This drawing illustrates a relation between frequencies of signals that occur in radio frequency circuit 1B and signal levels thereof. Specifically, the drawing illustrates spectra of (1) two transmission signals (frequencies f1 and f2) in Band B40 output from power amplifier 11, (2) one transmission signal (frequency f3) in Band B39 output from power amplifier 12, and (3) triple beat distortion (frequency f3−f1+f2) that occurs due to two transmission signals in Band B40 and one transmission signal in Band B39.

In this example, the first band (Band B40) is in a frequency range higher than a frequency range of the second band (Band B39).

In the above configuration, two transmission signals in Band B40 are two component carriers (CCs) within the same band, and thus triple beat primary distortions (frequencies f3−f1+f2 and f3+f1−f2) occur in the vicinity of Band B39. Here, one (frequency f3−f1+f2) of the triple beat primary distortions occurs in the vicinity of the frequency range higher than Band B39, and overlaps Band B34 received simultaneously with transmission of three transmission signals in Band B40 and Band B39.

To address this, according to radio frequency circuit 1B according to this example, in simultaneous transmission of two transmission signals in Band B40 for TDD and one transmission signal in Band B39 for TDD, even in a case in which triple beat primary distortion occurs in power amplifier 11 and/or power amplifier 12, (1) the output ends of power amplifiers 11 and 12 and the input end of low-noise amplifier 22 are not directly connected by switches, (2) the primary distortion component generated in power amplifier 11 is sufficiently attenuated by filter 31A, and (3) the primary distortion component generated in power amplifier 12 is sufficiently attenuated by filter 32A. Accordingly, high isolation can be ensured between low-noise amplifier 22 and power amplifiers 11 and 12, and thus deterioration of reception sensitivity in Band B34 in a case in which three transmission signals in Bands B40 and B39 are simultaneously transferred can be reduced.

### [1.5 Circuit Configuration of Radio Frequency Circuit 1C According to Example 3]

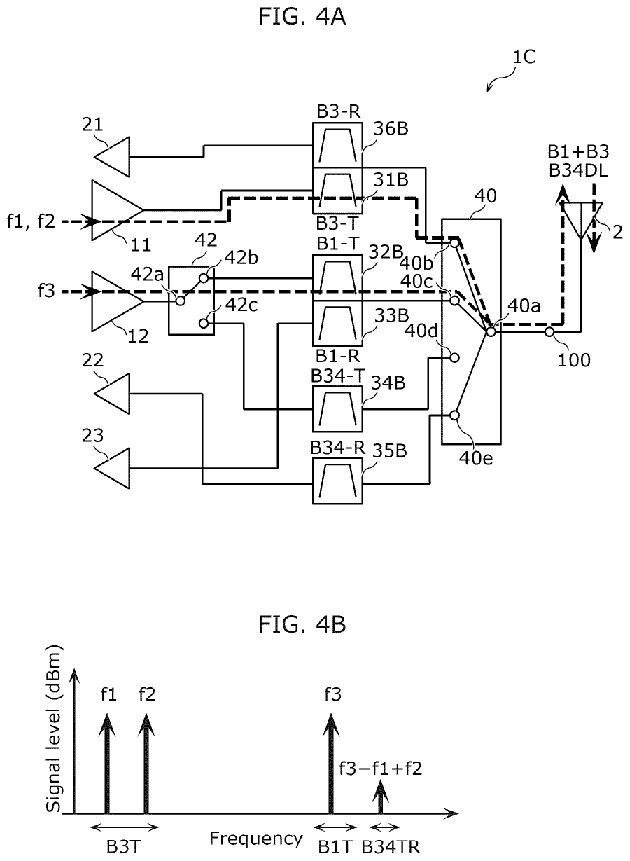

FIG. 4A illustrates a circuit configuration of radio frequency circuit 1C according to Example 3. As illustrated in the drawing, radio frequency circuit 1C includes power amplifiers 11 and 12, low-noise amplifiers 21, 22, and 23, switches 40 and 42, filters 31B, 32B, 33B, 34B, 35B, and 36B, and antenna connection terminal 100. Radio frequency circuit 1C according to this example is different from radio frequency circuit 1 according to the embodiment in a circuit configuration of a path for transferring signals in the first band. In the following, description of the same features of radio frequency circuit 1C according to this example as those of radio frequency circuit 1 according to the embodiment is omitted, and differences therefrom are mainly described.

Switch 40 is an example of a second switch, and has the same configuration as that of switch 40 according to the embodiment. Terminal 40a is connected to antenna 2 via antenna connection terminal 100. Terminal 40b is connected to the output end of filter 31B and the input end of filter 36B. Terminal 40c is connected to the output end of filter 32B and the input end of filter 33B. Terminal 40d is connected to the output end of filter 34B. Terminal 40e is connected to the input end of filter 35B.

Switch 42 has the same configuration as that of switch 42 according to the embodiment. Terminal 42a is connected to the output end of power amplifier 12, terminal 42b is connected to filter 32B, and terminal 42c is connected to filter 34B. Switch 42 selectively switches between transmission in the second band and transmission in the third band.

Filter 31B is an example of a first filter, and has a passband that includes at least a portion of the first band. Filter 31B is connected between power amplifier 11 and switch 40. Specifically, filter 31B has a passband that includes an uplink operating band of the first band. The input end of filter 31B is connected to the output end of power amplifier 11, and the output end of filter 31B is connected to terminal 40b.

Filter 36B has a passband that includes a downlink operating band of the first band. The input end of filter 36B is connected to terminal 40b, and the output end of filter 36B is connected to low-noise amplifier 21.

Filter 32B is an example of a second filter, and has a passband that includes at least a portion of the second band. Filter 32B has the same connection configuration as that of filter 32 according to the embodiment.

Filter 33B is an example of a fifth filter, and has a passband that includes a downlink operating band of the second band. Filter 33B has the same connection configuration as that of filter 33 according to the embodiment.

Filter 34B is an example of a third filter, and has a passband that includes the third band for TDD. Filter 34B has the same connection configuration as that of filter 34 according to the embodiment.

Filter 35B is an example of a fourth filter, and has a passband that includes the third band for TDD. Filter 35B has the same connection configuration as that of filter 35 according to the embodiment.

Radio frequency circuit 1C according to this example has a configuration in which single power amplifier 12 amplifies both a transmission signal in the second band and a transmission signal in the third band. Accordingly, the size of radio frequency circuit 1C can be decreased. On the other hand, as a filter that passes signals in the third band for TDD, filter 34B for transmission and filter 35B for reception are disposed. As a configuration that passes signals in the third band for TDD, a configuration that includes a single filter for both transmission and reception and a TDD switch is not adopted.

According to this, signals output from power amplifier 12 can be prevented from sneaking into a reception path for the third band via the TDD switch.

In radio frequency circuit 1C according to this example, the first band is an FDD band such as Band B3 for 4G LTE or Band n3 for 5G NR, for example. The second band is Band B1 for FDD (uplink operating band: 1920 MHz to 1980 MHz, downlink operating band: 2110 MHz to 2170 MHz) or Band n1 for 5G NR (uplink operating band: 1920 MHz to 1980 MHz, downlink operating band: 2110 MHz to 2170 MHz). The third band is a TDD band such as Band B34 for 4G LTE or Band n34 for 5G NR, for example.

In radio frequency circuit 1C, a mode of simultaneously transmitting two transmission signals in Band B3 (having frequencies f1 and f2) and one transmission signal in Band B1 (having frequency f3), and at the same time, receiving a reception signal in Band B34 (B1+B3+B34DL) is executed.

In this case, two transmission signals in Band B3 are output to antenna 2 via power amplifier 11, filter 31B, and switch 40. One transmission signal in Band B1 is output to antenna 2 via power amplifier 12, switch 42, filter 32B, and switch 40.

A reception signal in Band B34 is output to RFIC 3 via antenna 2, switch 40, filter 35B, and low-noise amplifier 22.

FIG. 4B illustrates an example in which triple beat distortion occurs in radio frequency circuit 1C according to Example 3. This drawing illustrates a relation between frequencies of signals that occur in radio frequency circuit 1C and signal levels thereof. Specifically, the drawing illustrates spectra of (1) two transmission signals (frequencies f1 and f2) in Band B3 output from power amplifier 11, (2) one transmission signal (frequency f3) in Band B1 output from power amplifier 12, and (3) triple beat distortion (frequency f3−f1+f2) that occurs due to two transmission signals in Band B3 and one transmission signal in Band B1.

In this example, the first band (Band B3) is in a frequency range lower than a frequency range of the second band (Band B1).

In the above configuration, two transmission signals in Band B3 are two component carriers (CCs) within the same band, and thus triple beat primary distortions (frequencies f3−f1+f2 and f3+f1−f2) occur in the vicinity of Band B1. Here, one (frequency f3−f1+f2) of the triple beat primary distortions occurs in the vicinity of the frequency range higher than Band B1, and overlaps Band B34 received simultaneously with transmission of three transmission signals in Band B3 and Band B1.

To address this, according to radio frequency circuit 1C according to this example, even in a case in which triple beat primary distortion occurs in power amplifier 11 and/or power amplifier 12 in simultaneous transmission of two transmission signals in Band B3 for FDD and one transmission signal in Band B1 for FDD, (1) the output ends of power amplifiers 11 and 12 and the input end of low-noise amplifier 22 are not directly connected by switches, (2) the primary distortion component generated in power amplifier 11 is sufficiently attenuated by filter 31B, and (3) the primary distortion component generated in power amplifier 12 is sufficiently attenuated by filter 32B. Accordingly, high isolation can be ensured between low-noise amplifier 22 and power amplifiers 11 and 12, and thus deterioration of reception sensitivity in Band B34 in a case in which three transmission signals in Bands B3 and B1 are simultaneously transferred can be reduced.

### [1.6 Circuit Configuration of Radio Frequency Circuit According to Comparative Example]

Here, for comparison, radio frequency circuits according to Comparative Examples 1 and 2 having conventional configurations are to be described.

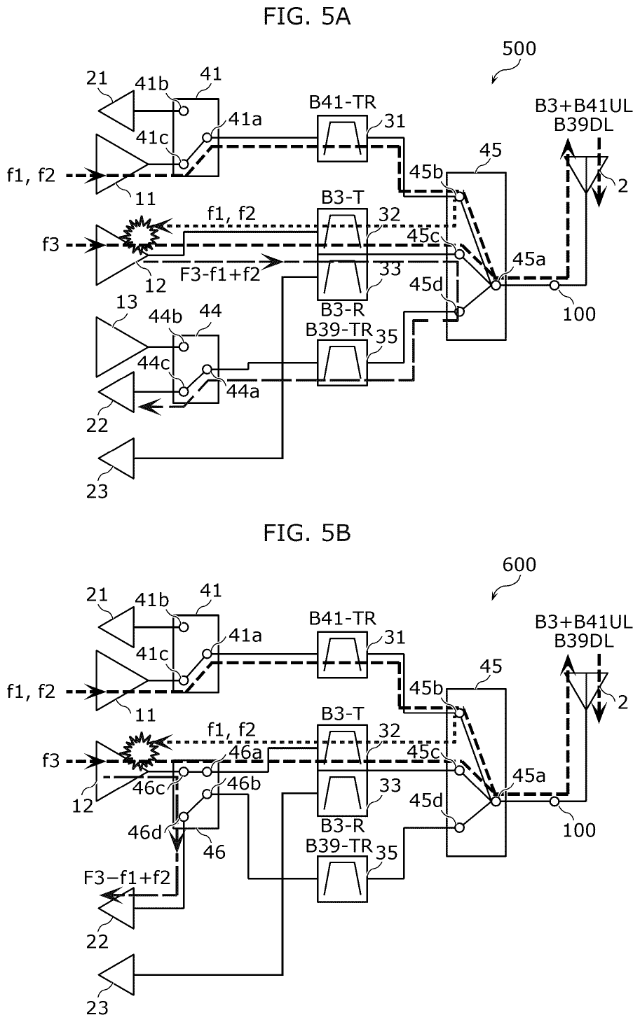

FIG. 5A illustrates a circuit configuration showing a signal transfer state of radio frequency circuit 500 according to Comparative Example 1. As illustrated in the drawing, radio frequency circuit 500 according to Comparative Example 1 includes power amplifiers 11, 12, and 13, low-noise amplifiers 21, 22, and 23, switches 41, 44, and 45, filters 31, 32, 33, and 35, and antenna connection terminal 100. Radio frequency circuit 500 according to this comparative example is different from radio frequency circuit 1 according to the embodiment in a circuit configuration of paths for transferring transmission signals in the second and third bands. In the following, description of the same features of radio frequency circuit 500 according to this comparative example as those of radio frequency circuit 1 according to the embodiment is omitted, and differences therefrom are mainly described.

Power amplifier 12 can amplify transmission signals in the second band output from RFIC 3. The output end of power amplifier 12 is connected to filter 32.

Power amplifier 13 can amplify transmission signals in the third band output from RFIC 3. The output end of power amplifier 13 is connected to terminal 44b of switch 44.

Low-noise amplifier 22 can amplify reception signals in the third band input via antenna connection terminal 100. The input end of low-noise amplifier 22 is connected to terminal 44c of switch 44.

Low-noise amplifier 23 can amplify reception signals in the second band input via antenna connection terminal 100. The input end of low-noise amplifier 23 is connected to filter 33.

Switch 45 includes terminals 45a, 45b, 45c, and 45d, and switches connection between terminal 45a and at least one of terminal 45b, 45c, or 45d. Terminal 45a is connected to antenna 2 via antenna connection terminal 100. Terminal 45b is connected to one end of filter 31. Terminal 45c is connected to the output end of filter 32 and the input end of filter 33. Terminal 45d is connected to one end of filter 35.

Switch 44 includes terminals 44a, 44b, and 44c, and selectively switches connection of terminal 44a between terminals 44b and 44c. Switch 44 is a TDD switch that switches between transmission and reception in the third band.

Filter 31 has a passband that includes at least a portion of the first band. Filter 31 is connected between power amplifier 11 and switch 45.

Filter 32 has a passband that includes an uplink operating band of the second band. Filter 32 is connected between power amplifier 12 and switch 45.

Filter 33 has a passband that includes a downlink operating band of the second band. Filter 33 is connected between low-noise amplifier 23 and switch 45.

Filter 35 has a passband that includes the third band for TDD. Filter 35 is connected between switch 44 and switch 45.

Radio frequency circuit 500 according to this comparative example has a configuration in which power amplifier 12 amplifies transmission signals in the second band, and power amplifier 13 amplifies transmission signals in the third band. Also, the configuration allows one filter 35 to pass transmission signals and reception signals in the third band. According to this, even in a case in which triple beat distortion occurs in power amplifier 11 and/or power amplifier 12 in simultaneous transmission of two transmission signals in the first band and one transmission signal in the second band, (1) the output ends of power amplifiers 11 and 12 and the input end of low-noise amplifier 22 are not directly connected by switches, (2) the primary distortion component generated in power amplifier 11 is sufficiently attenuated by filter 31, and (3) the primary distortion component generated in power amplifier 12 is sufficiently attenuated by filter 32. Thus, high isolation can be ensured between low-noise amplifier 22 and power amplifiers 11 and 12. However, radio frequency circuit 500 includes one fewer filter but one more power amplifier, as compared to radio frequency circuit 1 according to the embodiment. A power amplifier occupies a larger mounting space than the space for a filter, and thus radio frequency circuit 500 has a larger circuit scale than that of radio frequency circuit 1 according to the embodiment.

FIG. 5B illustrates a circuit configuration showing a signal transfer state of radio frequency circuit 600 according to Comparative Example 2. As illustrated in the drawing, radio frequency circuit 600 according to Comparative Example 2 includes power amplifiers 11 and 12, low-noise amplifiers 21, 22, and 23, switches 41, 45, and 46, filters 31, 32, 33, and 35, and antenna connection terminal 100. Radio frequency circuit 600 according to this comparative example is different from radio frequency circuit 1 according to the embodiment in a circuit configuration of paths for transferring transmission signals and reception signals in the third band. In the following, description of the same features of radio frequency circuit 600 according to this comparative example as those of radio frequency circuit 1 according to the embodiment is omitted, and differences therefrom are mainly described.

Power amplifier 12 can amplify transmission signals in the second band and the third band output from RFIC 3. The output end of power amplifier 12 is connected to terminal 46c of switch 46.

Low-noise amplifier 22 amplifies reception signals in the third band input via antenna connection terminal 100. The input end of low-noise amplifier 22 is connected to terminal 46d of switch 46.

Low-noise amplifier 23 can amplify reception signals in the second band input via antenna connection terminal 100. The input end of low-noise amplifier 23 is connected to filter 33.

Switch 45 includes terminals 45a, 45b, 45c, and 45d, and switches connection between terminal 45a and at least one of terminal 45b, 45c, or 45d. Terminal 45a is connected to antenna 2 via antenna connection terminal 100. Terminal 45b is connected to one end of filter 31. Terminal 45c is connected to the output end of filter 32 and the input end of filter 33. Terminal 45d is connected to one end of filter 35.

Switch 46 includes terminals 46a, 46b, 46c, and 46d, selectively switches connection of terminal 46c between terminals 46a and 46b, and switches between connection and disconnection of terminals 46d and 46b. Terminal 46a is connected to filter 32, terminal 46b is connected to filter 35, terminal 46c is connected to power amplifier 12, and terminal 46d is connected to low-noise amplifier 22. Switch 46 switches between transmission and reception in the third band and switches between transmission in the third band and transmission in the second band.

Filter 31 has a passband that includes at least a portion of the first band. Filter 31 is connected between power amplifier 11 and switch 45.

Filter 32 has a passband that includes an uplink operating band of the second band. Filter 32 is connected between switch 46 and switch 45.

Filter 33 has a passband that includes a downlink operating band of the second band. Filter 33 is connected between low-noise amplifier 23 and switch 45.

Filter 35 has a passband that includes the third band for TDD. Filter 35 is connected between switch 46 and switch 45.

In radio frequency circuit 600 according to this comparative example, the output end of power amplifier 12 and the input end of low-noise amplifier 22 are connected via switch 46. Accordingly, isolation between terminal 46c and terminal 46d of switch 46 is 20 dB to 30 dB, and is less by 20 dB than the attenuation of filter 32 (up to 50 dB). Here, in simultaneous transmission of two transmission signals in the first band and one transmission signal in the second band, in a case in which triple beat distortion occurs in power amplifier 12 and the frequency of the triple beat primary distortion at least partially overlaps the receiving band of the third band, a primary distortion component generated in power amplifier 12 enters low-noise amplifier 22 via switch 46, which deteriorates the reception sensitivity of the third band.

To address this, according to radio frequency circuit 1 according to the present embodiment, radio frequency circuit 1A according to Example 1, radio frequency circuit 1B according to Example 2, and radio frequency circuit 1C according to Example 3, even in a case in which triple beat distortion occurs in the first low-noise amplifier and/or the second power amplifier in simultaneous transmission of three transmission signals in the first band and the second band, (1) the second power amplifier can amplify transmission signals in the second band and the third band, (2) the output ends of the first power amplifier and the second power amplifier are not directly connected to the input end of the first low-noise amplifier via a switch, (3) the primary distortion component generated in the first low-noise amplifier is sufficiently attenuated by the first filter, and (4) the primary distortion component generated in the second power amplifier is sufficiently attenuated by the second filter. Accordingly, high isolation can be ensured between the first low-noise amplifier and the first and second power amplifiers, and thus a small radio frequency circuit with reception sensitivity less deteriorated in a case in which three transmission signals in two bands are simultaneously transferred can be provided.

### [1.7 Circuit Configuration of Radio Frequency Circuit 1D According to Example 4]

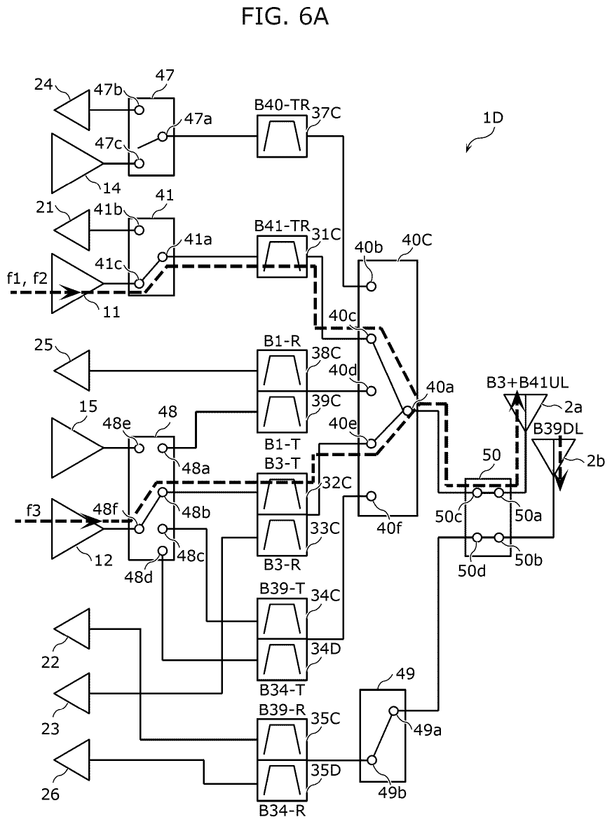

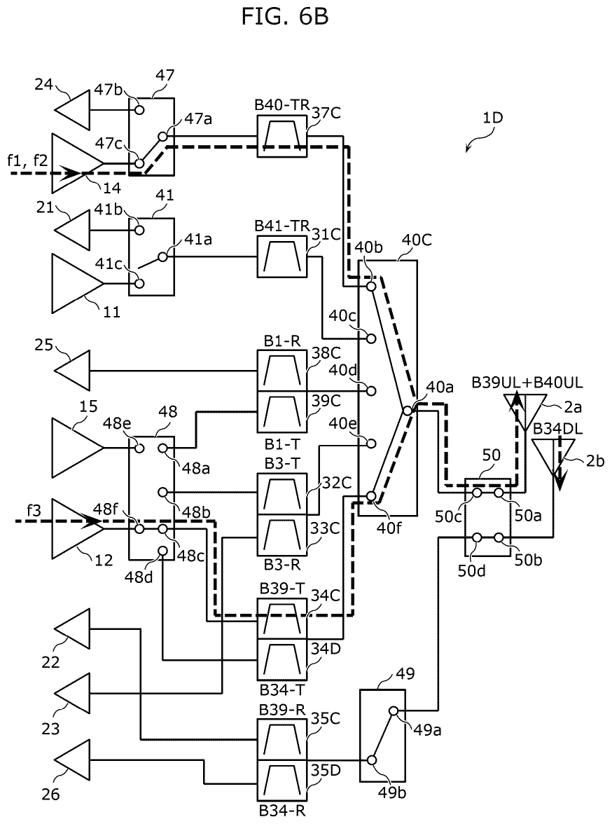

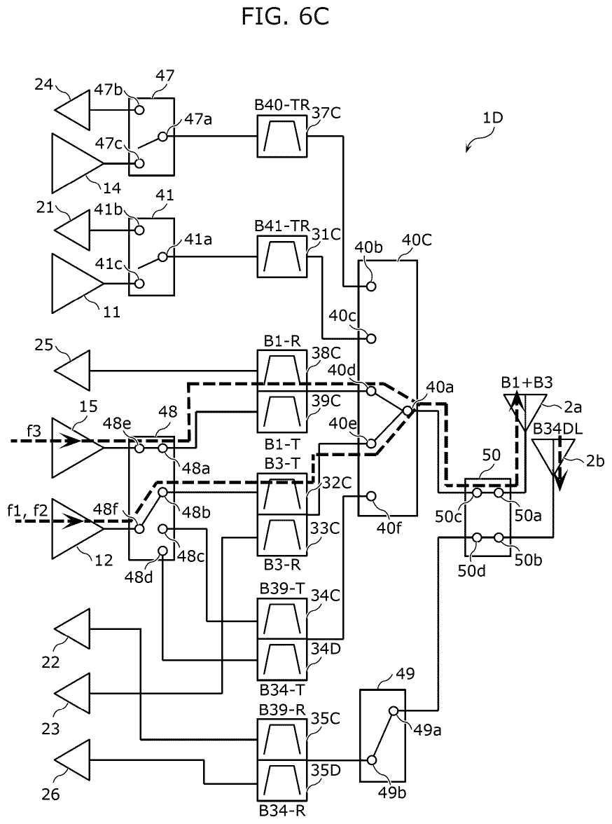

Next, a circuit configuration of radio frequency circuit 1D according to Example 4 is described with reference to FIG. 6A, FIG. 6B, and FIG. 6C.

FIG. 6A illustrates a circuit configuration showing a first signal transfer state of radio frequency circuit 1D according to Example 4. FIG. 6B illustrates a circuit configuration showing a second signal transfer state of radio frequency circuit 1D according to Example 4. FIG. 6C illustrates a circuit configuration showing a third signal transfer state of radio frequency circuit 1D according to Example 4.

FIG. 6A shows a first signal transfer state under a condition that two signals in Band B41 and one signal in Band B3 are simultaneously transmitted and a signal in Band B39 is simultaneously received. FIG. 6B shows a second signal transfer state under a condition that two signals in Band B40 and one signal in Band B39 are simultaneously transmitted and a signal in Band B34 is simultaneously received. FIG. 6C shows a third signal transfer state under a condition that two signals in Band B3 and one signal in Band B1 are simultaneously transmitted and a signal in Band B34 is simultaneously received.

As illustrated in FIG. 6A to FIG. 6C, radio frequency circuit 1D includes power amplifiers 11, 12, 14, and 15, low-noise amplifiers 21, 22, 23, 24, 25, and 26, switches 40C, 41, 47, 48, 49, and 50, and filters 31C, 32C, 33C, 34C, 34D, 35C, 35D, 37C, 38C, and 39C.

Power amplifier 14 is an example of a first power amplifier, and can amplify transmission signals in Band B40 output from RFIC 3. The output end of power amplifier 14 is connected to switch 47.

Power amplifier 11 is an example of a second power amplifier, and can amplify transmission signals in Band B41 output from RFIC 3. The output end of power amplifier 11 is connected to switch 41.

Power amplifier 15 is an example of a third power amplifier, and can amplify transmission signals in Bands B1, B3, B34, and B39 output from RFIC 3. The output end of power amplifier 15 is connected to terminal 48e of switch 48.

Power amplifier 12 is an example of a fourth power amplifier, and can amplify transmission signals in Bands B1, B3, B34, and B39 output from RFIC 3. The output end of power amplifier 12 is connected to terminal 48f of switch 48.

Low-noise amplifier 24 amplifies reception signals in Band B40 input from antenna 2a or 2b. The input end of low-noise amplifier 24 is connected to switch 47.

Low-noise amplifier 21 amplifies reception signals in Band B41 input from antenna 2a or 2b. The input end of low-noise amplifier 21 is connected to switch 41.

Low-noise amplifier 25 amplifies reception signals in Band B1 input from antenna 2a or 2b. The input end of low-noise amplifier is connected to filter 38C.

Low-noise amplifier 22 is an example of a first low-noise amplifier, and amplifies reception signals in Band B39 input from antenna 2a or 2b. The input end of low-noise amplifier 22 is connected to filter 35C.

Low-noise amplifier 23 amplifies reception signals in Band B3 input from antenna 2a or 2b. The input end of low-noise amplifier 23 is connected to filter 33C.

Low-noise amplifier 26 is an example of a second low-noise amplifier, and amplifies reception signals in Band B34 input from antenna 2a or 2b. The input end of low-noise amplifier 26 is connected to filter 35D.

Switch 48 is an example of a first switch, includes terminals 48a, 48b, 48c, 48d, 48e, and 48f, switches connection between terminal 48e and at least one of terminal 48a, 48b, 48c, or 48d, and switches connection between terminal 48f and at least one of terminal 48a, 48b, 48c, or 48d.

Switch 40C is an example of a second switch, includes terminals 40a, 40b, 40c, 40d, 40e, and 40f, and switches connection between terminal 40a and at least one of terminal 40b, 40c, 40d, 40e, or 40f. Terminal 40a is connected to terminal 50c. Terminal 40b is connected to one end of filter 37C. Terminal 40c is connected to one end of filter 31C. Terminal 40d is connected to the input end of filter 38C and the output end of filter 39C. Terminal 40e is connected to the output end of filter 32C and the input end of filter 33C. Terminal 40f is connected to the output end of filter 34C and the output end of filter 34D.

Switch 49 is an example of a third switch, includes terminals 49a and 49b, and switches between connection and disconnection of terminals 49a and 49b. Terminal 49a is connected to terminal 50d, and terminal 49b is connected to the input end of filter 35C and the input end of filter 35D.

Switch 50 is an example of a fourth switch, includes terminals 50a, 50b, 50c, and 50d, and switches between (i) connection of terminals 50a and 50c and connection of terminals 50b and 50d and (ii) connection of terminals 50a and 50d and connection of terminals 50b and 50c.

Terminal 50a is connected to antenna 2a, terminal 50b is connected to antenna 2b, terminal 50c is connected to terminal 40a, and terminal 50d is connected to terminal 49a.

Filter 37C is an example of a first filter, and has a passband that includes Band B40. Filter 37C is connected between power amplifier 14 and switch 40C.

Filter 31C is an example of a second filter, and has a passband that includes Band B41. Filter 31C is connected between power amplifier 11 and switch 40C.

Filter 38C has a passband that includes a downlink operating band of Band B1. Filter 38C is connected between low-noise amplifier 25 and switch 40C.

Filter 39C is an example of a third filter, and has a passband that includes the uplink operating band of Band B1. Filter 39C is connected between switch 48 and switch 40C.

Filter 32C is an example of a fourth filter, and has a passband that includes the uplink operating band of Band B3. Filter 32C is connected between switch 48 and switch 40C.

Filter 33C has a passband that includes a downlink operating band of Band B3. Filter 33C is connected between low-noise amplifier 23 and switch 40C.

Filter 34C is an example of a fifth filter, and has a passband that includes Band B39. Filter 34C is connected between switch 48 and switch 40C.

Filter 34D is an example of a sixth filter, and has a passband that includes Band B34. Filter 34D is connected between switch 48 and switch 40C.

Filter 35C is an example of a seventh filter, and has a passband that includes Band B39. Filter 35C is connected between low-noise amplifier 22 and switch 49. Filter 35C is connected directly to low-noise amplifier 22, not through switch 48.

Filter 35D is an example of an eighth filter, and has a passband that includes Band B34. Filter 35D is connected between low-noise amplifier 26 and switch 49. Filter 35D is connected directly to low-noise amplifier 26, not through switch 48.

As illustrated in FIG. 6A, in radio frequency circuit 1D, a mode of simultaneously transmitting two transmission signals in Band B41 (having frequencies f1 and f2) and one transmission signal in Band B3 (having frequency f3), and at the same time, receiving a reception signal in Band B39 and a reception signal in Band B3 (B3+B41UL+B39DL) is executed.

In this case, two transmission signals in Band B41 are output to antenna 2a via power amplifier 11, switch 41, filter 31C, and switches 40C and 50. One transmission signal in Band B3 is output to antenna 2a via power amplifier 12, switch 48, filter 32C, and switches 40C and 50.

A reception signal in Band B39 is output to RFIC 3 via antenna 2b, switch 50, switch 49, filter 35C, and low-noise amplifier 22. A reception signal in Band B3 is output to RFIC 3 via antenna 2a, switch 50, switch 40C, filter 33C, and low-noise amplifier 23.

According to radio frequency circuit 1D according to this example, even in a case in which triple beat primary distortion occurs in power amplifier 11 and/or power amplifier 12 in simultaneous transmission of two transmission signals in Band B41 for TDD and one transmission signal in Band B3 for FDD, (1) the output ends of power amplifiers 11 and 12 and the input end of low-noise amplifier 22 are not directly connected by switches, (2) the primary distortion component generated in power amplifier 11 is sufficiently attenuated by filter 31C, and (3) the primary distortion component generated in power amplifier 12 is sufficiently attenuated by filter 32C. Thus, high isolation can be secured between low-noise amplifier 22 and power amplifiers 11 and 12, and thus deterioration of reception sensitivity in Band B39 in a case in which three transmission signals in Bands B41 and B3 are simultaneously transferred can be reduced.

As illustrated in FIG. 6B, in radio frequency circuit 1D, a mode of simultaneously transmitting two transmission signals in Band B40 (having frequencies f1 and f2) and one transmission signal in Band B39 (having frequency f3) and at the same time, receiving a reception signal in Band B34 (B39UL+B40UL+B34DL) is executed.

In this case, two transmission signals in Band B40 are output to antenna 2a via power amplifier 14, switch 47, filter 37C, and switches 40C and 50. One transmission signal in Band B39 is output to antenna 2a via power amplifier 12, switch 48, filter 34C, and switches 40C and 50.

A reception signal in Band B34 is output to RFIC 3 via antenna 2b, switch 50, switch 49, filter 35D, and low-noise amplifier 26.

According to radio frequency circuit 1D according to this example, even in a case in which triple beat primary distortion occurs in power amplifier 14 and/or power amplifier 12 in simultaneous transmission of two transmission signals in Band B40 for TDD and one transmission signal in Band B39 for TDD, (1) the output ends of power amplifiers 14 and 12 and the input end of low-noise amplifier 26 are not directly connected by switches, (2) the primary distortion component generated in power amplifier 14 is sufficiently attenuated by filter 37C, and (3) the primary distortion component generated in power amplifier 12 is sufficiently attenuated by filter 34C. Accordingly, high isolation can be ensured between low-noise amplifier 26 and power amplifiers 14 and 12, and thus deterioration of reception sensitivity in Band B34 in a case in which three transmission signals in Bands B40 and B39 are simultaneously transferred can be reduced.

As illustrated in FIG. 6C, in radio frequency circuit 1D, a mode of simultaneously transmitting two transmission signals in Band B3 (having frequencies f1 and f2) and one transmission signal in Band B1 (having frequency f3) and at the same time, receiving a reception signal in Band B34 (B1+B3+B34DL) is executed.

In this case, two transmission signals in Band B3 are output to antenna 2a via power amplifier 12, switch 48, filter 32C, and switches 40C and 50. One transmission signal in Band B1 is output to antenna 2a via power amplifier 15, switch 48, filter 39C, and switches 40C and 50.

A reception signal in Band B34 is output to RFIC 3 via antenna 2b, switch 50, switch 49, filter 35D, and low-noise amplifier 26.

According to radio frequency circuit 1D according to this example, even in a case in which triple beat primary distortion occurs in power amplifier 12 and/or power amplifier 15 in simultaneous transmission of two transmission signals in Band B3 for FDD and one transmission signal in Band B1 for FDD, (1) the output ends of power amplifiers 12 and 15 and the input end of low-noise amplifier 26 are not directly connected by switches, (2) the primary distortion component generated in power amplifier 12 is sufficiently attenuated by filter 32C, and (3) the primary distortion component generated in power amplifier 15 is sufficiently attenuated by filter 39C. Accordingly, high isolation can be ensured between low-noise amplifier 26 and power amplifiers 12 and 15, and thus deterioration of reception sensitivity in Band B34 in a case in which three transmission signals in Bands B3 and B1 are simultaneously transferred can be reduced.

### [1.8 Circuit Configuration of Radio Frequency Circuit 1E According to Example 5]

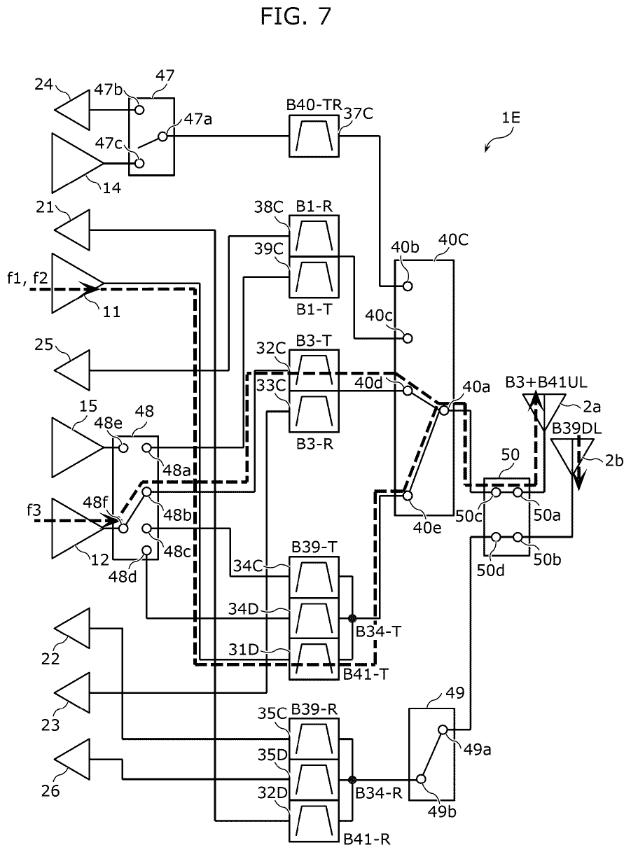

Next, a circuit configuration of radio frequency circuit 1E according to Example 5 is described with reference to FIG. 7.

FIG. 7 illustrates a circuit configuration showing a signal transfer state of radio frequency circuit 1E according to Example 5. As illustrated in the drawing, radio frequency circuit 1E includes power amplifiers 11, 12, 14, and 15, low-noise amplifiers 21, 22, 23, 24, 25, and 26, switches 40C, 47, 48, 49, and 50, and filters 31D, 32C, 32D, 33C, 34C, 34D, 35C, 35D, 37C, 38C, and 39C. Radio frequency circuit 1E according to this example is different from radio frequency circuit 1D according to Example 4 in a circuit configuration of a path for transferring signals in Band B41. In the following, description of the same features of radio frequency circuit 1E according to this example as those of radio frequency circuit 1D according to Example 4 is omitted, and differences therefrom are mainly described.

Power amplifier 14 is an example of a first power amplifier, and can amplify transmission signals in Band B40 output from RFIC 3. The output end of power amplifier 14 is connected to switch 47.

Power amplifier 11 is an example of a second power amplifier, and can amplify transmission signals in Band B41 output from RFIC 3. The output end of power amplifier 11 is connected to filter 31D.

Power amplifier 15 is an example of a third power amplifier, and can amplify transmission signals in Bands B1, B3, B34, and B39 output from RFIC 3. The output end of power amplifier 15 is connected to terminal 48e of switch 48.

Power amplifier 12 is an example of a fourth power amplifier, and can amplify transmission signals in Bands B1, B3, B34, and B39 output from RFIC 3. The output end of power amplifier 12 is connected to terminal 48f of switch 48.

Low-noise amplifier 21 amplifies reception signals in Band B41 input from antenna 2a or 2b. The input end of low-noise amplifier 21 is connected to filter 32D.

Low-noise amplifier 22 is an example of a first low-noise amplifier, and amplifies reception signals in Band B39 input from antenna 2a or 2b. The input end of low-noise amplifier 22 is connected to filter 35C.

Low-noise amplifier 26 is an example of a second low-noise amplifier, and amplifies reception signals in Band B34 input from antenna 2a or 2b. The input end of low-noise amplifier 26 is connected to filter 35D.

Switch 48 is an example of a first switch, includes terminals 48a, 48b, 48c, 48d, 48e, and 48f, switches connection between terminal 48e and at least one of terminal 48a, 48b, 48c, or 48d, and switches connection between terminal 48f and at least one of terminal 48a, 48b, 48c, or 48d.

Switch 40C is an example of a second switch, includes terminals 40a (first terminal), 40b (second terminal), 40c (third terminal), 40d (fourth terminal), and 40e (fifth terminal), and switches connection between terminal 40a and at least one of terminal 40b, 40c, 40d, or 40e. Terminal 40a is connected to terminal 50c. Terminal 40b is connected to one end of filter 37C. Terminal 40c is connected to the input end of filter 38C and the output end of filter 39C. Terminal 40d is connected to the output end of filter 32C and the input end of filter 33C. Terminal 40e is connected to the output end of filter 34C, the output end of filter 34D, and the output end of filter 31D. Switch 40C is connected between switch 50 and filters 37C, 38C, 39C, 32C, 33C, 34C, 34D, and 31D.

Switch 49 is an example of a third switch, includes terminals 49a (sixth terminal) and 49b (seventh terminal), and switches between connection and disconnection of terminals 49a and 49b. Terminal 49a is connected to terminal 50d, and terminal 49b is connected to the input end of filter 35C, the input end of filter 35D, and the input end of filter 32D. Switch 49 is connected between switch 50 and filters 35C, 35D, and 32D.

Switch 50 is an example of a fourth switch, includes terminal 50a (first antenna terminal), 50b (second antenna terminal), 50c (first selection terminal), and 50d (second selection terminal), and switches between (i) connection of terminals 50a and 50c and connection of terminals 50b and 50d and (ii) connection of terminals 50a and 50d and connection of terminals 50b and 50c.

Terminal 50a is connected to antenna 2a, terminal 50b is connected to antenna 2b, terminal 50c is connected to terminal 40a, and terminal 50d is connected to terminal 49a.

Filter 37C is an example of a first filter, and has a passband that includes Band B40. Filter 37C is connected between power amplifier 14 and switch 40C.

Filter 31D is an example of a second filter, and has a passband that includes Band B41. Filter 31D is connected between power amplifier 11 and switch 40C.

Filter 32D has a passband that includes Band B41. Filter 32D is connected between low-noise amplifier 21 and switch 49.

Filter 38C has a passband that includes the downlink operating band of Band B1. Filter 38C is connected between low-noise amplifier 25 and switch 40C.

Filter 39C is an example of a third filter, and has a passband that includes the uplink operating band of Band B1. Filter 39C is connected between switch 48 and switch 40C.

Filter 32C is an example of a fourth filter, and has a passband that includes the uplink operating band of Band B3. Filter 32C is connected between switch 48 and switch 40C.

Filter 33C has a passband that includes the downlink operating band of Band B3. Filter 33C is connected between low-noise amplifier 23 and switch 40C.

Filter 34C is an example of a fifth filter, and has a passband that includes Band B39. Filter 34C is connected between switch 48 and switch 40C.

Filter 34D is an example of a sixth filter, and has a passband that includes Band B34. Filter 34D is connected between switch 48 and switch 40C.

Filter 35C is an example of a seventh filter, and has a passband that includes Band B39. Filter 35C is connected between low-noise amplifier 22 and switch 49. Filter 35C is connected directly to low-noise amplifier 22, not through switch 48.

Filter 35D is an example of an eighth filter, and has a passband that includes Band B34. Filter 35D is connected between low-noise amplifier 26 and switch 49. Filter 35D is connected directly to low-noise amplifier 26, not through switch 48.

According to radio frequency circuit 1E according to this example, even in a case in which triple beat primary distortion occurs in power amplifier 11 and/or power amplifier 12 in simultaneous transmission of two transmission signals in Band B41 for TDD and one transmission signal in Band B3 for FDD, high isolation can be ensured between low-noise amplifier 22 and power amplifiers 11 and 12, and thus deterioration of reception sensitivity in Band B39 in a case in which three transmission signals in Band B41 and Band B3 are simultaneously transferred can be reduced.

Even in a case in which triple beat primary distortion occurs in power amplifier 14 and/or power amplifier 12 in simultaneous transmission of two transmission signals in Band B40 for TDD and one transmission signal in Band B39 for TDD, high isolation can be ensured between low-noise amplifier 26 and power amplifiers 14 and 12, and thus deterioration of reception sensitivity in Band B34 in a case in which three transmission signals in Band B40 and Band B39 are simultaneously transferred can be reduced.

Even in a case in which triple beat primary distortion occurs in power amplifier 12 and/or power amplifier 15 in simultaneous transmission of two transmission signals in Band B3 for FDD and one transmission signal in Band B1 for FDD, high isolation can be ensured between low-noise amplifier 26 and power amplifiers 12 and 15, and thus deterioration of reception sensitivity in Band B34 in a case in which three transmission signals in Band B3 and Band B1 are simultaneously transferred can be reduced.

A filter for Band B41 is divided into filter 31D for transmission and filter 32D for reception, filters 31D, 34C, and 34D for transmission are connected to one terminal 40e, and filters 32D, 35C, and 35D for reception are connected to one terminal 49b, and thus the number of terminals of switch 40C can be reduced as compared to radio frequency circuit 1D according to Example 4. Accordingly, signal transfer loss in switch 40C can be reduced.

### [1.9 Circuit Configuration of Radio Frequency Circuit 1F According to Example 6]

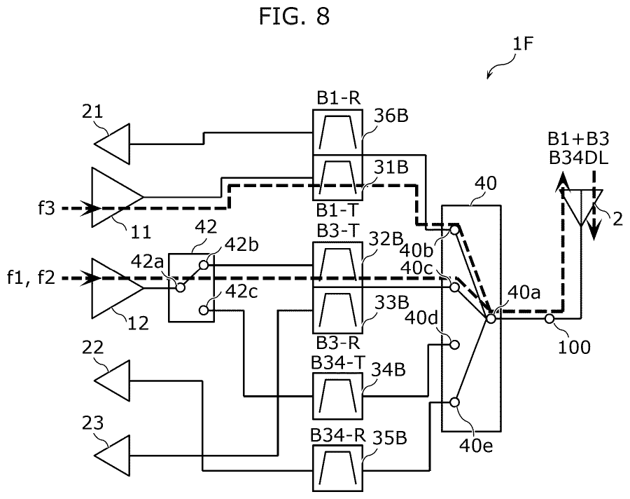

Next, a circuit configuration of radio frequency circuit 1F according to Example 6 is described with reference to FIG. 8.

FIG. 8 illustrates a circuit configuration showing a signal transfer state of radio frequency circuit 1F according to Example 6. As illustrated in the drawing, radio frequency circuit 1F includes power amplifiers 11 and 12, low-noise amplifiers 21, 22, and 23, switches and 42, filters 31B, 32B, 33B, 34B, 35B, and 36B, and antenna connection terminal 100. Radio frequency circuit 1F according to this example is different from radio frequency circuit 1C according to Example 3 in that two signals in the second band and one signal in the first band are simultaneously transmitted, rather than two signals in the first band and one signal in the second band are simultaneously transmitted. In the following, description of the same features of radio frequency circuit 1F according to this example as those of radio frequency circuit 1C according to Example 3 is omitted, and differences therefrom are mainly described.

Switch 40 is an example of a second switch, and has the same configuration as that of switch 40 according to Example 3. Switch 42 has the same configuration as that of switch 42 according to Example 3.

Filter 31B is an example of a first filter, and has a passband that includes at least a portion of the first band, and has the same configuration as that of filter 31B according to Example 3. Filter 36B has the same configuration as that of filter 36B according to Example 3. Filter 32B is an example of a second filter, and has a passband that includes at least a portion of the second band, and has the same configuration as that of filter 32B according to Example 3. Filter 34B is an example of a third filter, and has the same configuration as that of filter 34B according to Example 3. Filter 35B is an example of a fourth filter, and has the same configuration as that of filter 35B according to Example 3. Filter 35B is connected directly to low-noise amplifier 22, not through switch 42.

In radio frequency circuit 1F according to this example, the first band is an FDD band such as Band B1 for 4G LTE or Band n1 for 5G NR, for example. The second band is an FDD band such as Band B3 or Band n3 for 5G NR, for example. The third band is a TDD band such as Band B34 for 4G LTE or Band n34 for 5G NR, for example. In radio frequency circuit 1F, a mode of simultaneously transmitting two transmission signals in Band B3 (having frequencies f1 and f2) and one transmission signal in Band B1 (having frequency f3) and at the same time, receiving a reception signal in Band B34 (B1+B3+B34DL) is executed.

In this case, one transmission signals in Band B1 is output to antenna 2 via power amplifier 11, filter 31B, and switch 40. Two transmission signals in Band B3 are output to antenna 2 via power amplifier 12, switch 42, filter 32B, and switch 40.

A reception signal in Band B34 is output to RFIC 3 via antenna 2, switch 40, filter 35B, and low-noise amplifier 22.

In this example, the first band (Band B1) is in a frequency range higher than a frequency range of the second band (Band B3).

In the above configuration, two transmission signals in Band B3 are two component carriers (CCs) within the same band, and thus triple beat primary distortions (frequencies f3−f1+f2 and f3+f1−f2) occur in the vicinity of Band B1. Here, one (frequency f3−f1+f2) of the triple beat primary distortions occurs in the vicinity of the frequency range higher than Band B1, and overlaps Band B34 received simultaneously with transmission of three transmission signals in Band B3 and Band B1.

To address this, according to radio frequency circuit 1F according to this example, even in a case in which triple beat primary distortion occurs in power amplifier 11 and/or power amplifier 12 in simultaneous transmission of two transmission signals in Band B3 for FDD and one transmission signal in Band B1 for FDD, (1) the output ends of power amplifiers 11 and 12 and the input end of low-noise amplifier 22 are not directly connected by switches, (2) the above primary distortion component generated in power amplifier 11 is sufficiently attenuated by filter 31B, and (3) the above primary distortion component generated in power amplifier 12 is sufficiently attenuated by filter 32B. Accordingly, high isolation can be ensured between low-noise amplifier 22 and power amplifiers 11 and 12, and thus deterioration of reception sensitivity in Band B34 in a case in which three transmission signals in Bands B3 and B1 are simultaneously transferred can be reduced.

### 2 Advantageous Effects and Others

As described above, radio frequency circuit 1 according to the present embodiment includes: power amplifiers 11 and 12; low-noise amplifier 22; switches 42 and 40; filter 31 having a passband that includes at least a portion of a first band; filter 32 having a passband that includes at least a portion of a second band; filter 34 having a passband that includes a third band for TDD; and filter 35 having a passband that includes the third band for TDD. A frequency obtained by subtracting a frequency of one signal from a sum of frequencies of two signals overlaps the third band, the two signals being randomly selected from among two signals having different frequencies in the first band and a signal having a frequency in the second band, the one signal being a remaining signal, filter 31 is connected between power amplifier 11 and switch 40, power amplifier 12 is connected to switch 42, filter 32 is connected between switch 42 and switch 40, filter 34 is connected between switch 42 and switch 40, and filter 35 is connected between low-noise amplifier 22 and switch 40.

According to this, even in a case in which triple beat distortion occurs in power amplifier 11 and/or power amplifier 12 in simultaneous transmission of two transmission signals in the first band and one transmission signal in the second band, (1) the output ends of power amplifiers 11 and 12 and the input end of low-noise amplifier 22 are not directly connected by switches, (2) the primary distortion component generated in power amplifier 11 is sufficiently attenuated by filter 31, and (3) the primary distortion component generated in power amplifier 12 is sufficiently attenuated by filter 32. Accordingly, high isolation can be ensured between low-noise amplifier 22 and power amplifiers 11 and 12, and thus deterioration of reception sensitivity in a case in which three transmission signals in two bands are simultaneously transferred can be reduced.

For example, in radio frequency circuit 1, switch 42 includes terminals 42a, 42b, and 42c, terminal 42a is connected to an output end of power amplifier 12, terminal 42b is connected to filter 32, and terminal 42c is connected to filter 34.

According to this, power amplifier 12 can be connected to one of filter 32 or 34.

For example, in radio frequency circuit 1, switch 42 is configured to selectively switch connection of terminal 42a between terminal 42b and terminal 42c.

According to this, power amplifier 12 can selectively amplify a signal in the second band or a signal in the third band.

For example, in radio frequency circuit 1, switch 40 includes terminals 40a, 40b, 40c, 40d, and 40e, and is configured to switch connection between terminal 40a and at least one of terminal 40b, 40c, 40d, or 40e, terminal 40b is connected to filter 31, terminal 40c is connected to filter 32, terminal 40d is connected to filter 34, and terminal 40e is connected to filter 35.

According to this, switch 40 can ensure isolation between transmission and reception in the first band, transmission and reception in the second band, transmission in the third band, and reception in the third band.

For example, in radio frequency circuit 1A according to Example 1, the first band is a TDD band, the second band is an FDD band, the passband of filter 32 includes an uplink operating band of the second band, radio frequency circuit 1A further includes: filter 33 having a passband that includes a downlink operating band of the second band; and low-noise amplifier 23, and filter 33 is connected between low-noise amplifier 23 and switch 40.

According to this, even in a case in which triple beat distortion occurs in power amplifier 11 and/or power amplifier 12 in simultaneous transmission of two transmission signals in the TDD band and one transmission signal in the FDD band, (1) the output ends of power amplifiers 11 and 12 and the input end of low-noise amplifier 22 are not directly connected by switches, (2) the primary distortion component generated in power amplifier 11 is sufficiently attenuated by filter 31, and (3) the primary distortion component generated in power amplifier 12 is sufficiently attenuated by filter 32.

Accordingly, high isolation can be ensured between low-noise amplifier 22 and power amplifiers 11 and 12, and thus deterioration of reception sensitivity in a case in which three transmission signals in two bands are simultaneously transferred can be reduced.

For example, in radio frequency circuit 1A according to Example 1, the first band is in a frequency range higher than a frequency range of the second band.

According to this, for example, even in a case in which the frequency of triple beat distortion that occurs in simultaneous transmission of two signals in the first band that belongs to a high-band group (2.4 GHz to 2.8 GHZ) and one signal in the second band that belongs to a middle band group (1.5 GHZ to 2.4 GHZ) overlaps the third band that belongs to the middle band group, deterioration of reception sensitivity can be reduced.

For example, in radio frequency circuit 1A according to Example 1, the first band is Band B41 for 4G LTE or Band n41 for 5G NR, the second band is Band B3 for 4G LTE or Band n3 for 5G NR, and the third band is Band B39 for 4G LTE or Band n39 for 5G NR.

For example, in radio frequency circuit 1B according to Example 2, the first band is a TDD band, the second band is a TDD band, the passband of filter 32A includes the second band, radio frequency circuit 1B further includes: switch 43; and low-noise amplifier 23, and switch 43 is connected between switch 42 and filter 32A and between low-noise amplifier 23 and filter 32A.

According to this, even in a case in which triple beat distortion occurs in power amplifier 11 and/or power amplifier 12 in simultaneous transmission of two transmission signals in the TDD band and one transmission signal in the TDD band, (1) the output ends of power amplifiers 11 and 12 and the input end of low-noise amplifier 22 are not directly connected by switches, (2) the primary distortion component generated in power amplifier 11 is sufficiently attenuated by filter 31A, and (3) the primary distortion component generated in power amplifier 12 is sufficiently attenuated by filter 32A. Accordingly, high isolation can be ensured between low-noise amplifier 22 and power amplifiers 11 and 12, and thus deterioration of reception sensitivity in a case in which three transmission signals in two bands are simultaneously transferred can be reduced.

For example, in radio frequency circuit 1B according to Example 2, the first band is in a frequency range higher than a frequency range of the second band.

According to this, for example, even in a case in which the frequency of triple beat distortion that occurs in simultaneous transmission of two signals in the first band that belongs to a high-band group (2.4 GHz to 2.8 GHZ) and one signal in the second band that belongs to a middle band group (1.5 GHZ to 2.4 GHZ) overlaps the third band that belongs to the middle band group, deterioration of reception sensitivity can be reduced.

For example, in radio frequency circuit 1B according to Example 2, the first band is Band B40 for 4G LTE or Band n40 for 5G NR, the second band is Band B39 for 4G LTE or Band n39 for 5G NR, and the third band is Band B34 for 4G LTE or Band n34 for 5G NR.

For example, in radio frequency circuit 1C according to Example 3, the first band is an FDD band, the second band is an FDD band, the passband of filter 31B includes an uplink operating band of the first band, the passband of filter 32B includes an uplink operating band of the second band, radio frequency circuit 1C further includes: filter 33B having a passband that includes a downlink operating band of the second band; and low-noise amplifier 23, and filter 33B is connected between low-noise amplifier 23 and switch 40.

According to this, even in a case in which triple beat distortion occurs in power amplifier 11 and/or power amplifier 12 in simultaneous transmission of two transmission signals in the FDD band and one transmission signal in the FDD band, (1) the output ends of power amplifiers 11 and 12 and the input end of low-noise amplifier 22 are not directly connected by switches, (2) the primary distortion component generated in power amplifier 11 is sufficiently attenuated by filter 31B, and (3) the primary distortion component generated in power amplifier 12 is sufficiently attenuated by filter 32B. Accordingly, high isolation can be ensured between low-noise amplifier 22 and power amplifiers 11 and 12, and thus deterioration of reception sensitivity in a case in which three transmission signals in two bands are simultaneously transferred can be reduced.

For example, in radio frequency circuit 1C according to Example 3, the first band is in a frequency range lower than a frequency range of the second band.

According to this, for example, even in a case in which the frequency of triple beat distortion that occurs in simultaneous transmission of two signals in the first band that belongs to a middle-band group (1.5 GHZ to 2.4 GHZ) and one signal in the second band that belongs to a high band group (2.4 GHz to 2.8 GHZ) overlaps the third band that belongs to the high band group, deterioration of reception sensitivity can be reduced.

For example, in radio frequency circuit 1C according to Example 3, the first band is Band B3 for 4G LTE or Band n3 for 5G NR, the second band is Band B1 for 4G LTE or Band n1 for 5G NR, and the third band is Band B34 for 4G LTE or Band n34 for 5G NR.

For example, in radio frequency circuit 1, the third band is capable of supporting Power Class 2.

In radio frequency circuit 1, filter 34 for transmission in the third band for TDD and filter 35 for reception in the third band for TDD have different structures or different properties, so that the third band can be applied to a band that can support Power Class 2 that is a high power class. For example, filter 34 may have a structure that focuses on low loss in the passband, and filter 35 may have a structure that focuses on the attenuation in the attenuation band.

Radio frequency circuit 1E according to Example 5 (and radio frequency circuit 1D according to Example 4): power amplifier 11, 12, 14, and 15; low-noise amplifiers 22 and 26; switches 40C, 47, 48, and 49; filter 37C having a passband that includes Band B40; filter 31D having a passband that includes Band B41; filter 39C having a passband that includes an uplink operating band of Band B1; filter 32C having a passband that includes an uplink operating band of Band B3; filter 34C having a passband that includes Band B39; filter 34D having a passband that includes Band B34; filter 35C having a passband that includes Band B39; and filter 35D having a passband that includes Band B34. Filter 37C is connected between power amplifier 14 and switch 40C. Filter 31D is connected between power amplifier 11 and switch 40C, power amplifier 15 is connected to switch 48, filter 39C is connected between switch 48 and switch 40C, power amplifier 12 is connected to switch 48, filter 32C is connected between switch 48 and switch 40C, filter 34C is connected between switch 48 and switch 40C, filter 34D is connected between switch 48 and switch 40C, filter 35C is connected between low-noise amplifier 22 and switch 49, filter 35D is connected between low-noise amplifier 26 and switch 49, switch 40C is connected between (i) switch 50 and (ii) filters 37C, 39C, 32C, 34C, 34D, and 31D, and switch 49 is connected between (i) switch 50 and (ii) filters 35C and 35D.

According to this, even in a case in which triple beat primary distortion occurs in power amplifier 11 and/or power amplifier 12 in simultaneous transmission of two transmission signals in Band B41 for TDD and one transmission signal in Band B3 for FDD, high isolation can be ensured between low-noise amplifier 22 and power amplifiers 11 and 12, and thus deterioration of reception sensitivity in Band B39 in a case in which three transmission signals in Band B41 and Band B3 are simultaneously transferred can be reduced.

Even in a case in which triple beat primary distortion occurs in power amplifier 14 and/or power amplifier 12 in simultaneous transmission of two transmission signals in Band B40 for TDD and one transmission signal in Band B39 for TDD, high isolation can be ensured between low-noise amplifier 26 and power amplifiers 14 and 12, and thus deterioration of reception sensitivity in Band B34 in a case in which three transmission signals in Band B40 and Band B39 are simultaneously transferred can be reduced.

Even in a case in which triple beat primary distortion occurs in power amplifier 12 and/or power amplifier 15 in simultaneous transmission of two transmission signals in Band B3 for FDD and one transmission signal in Band B1 for FDD, high isolation can be ensured between low-noise amplifier 26 and power amplifiers 12 and 15, and thus deterioration of reception sensitivity in Band B34 in a case in which three transmission signals in Band B3 and Band B1 are simultaneously transferred can be reduced.

For example, in radio frequency circuit 1E, switch 40C includes terminals 40a, 40b, 40c, 40d, and 40e, and is configured to switch connection between terminal 40a and at least one of terminal 40b, 40c, 40d, or 40e, switch 49 includes terminals 49a and 49b, and is configured to switch between connection and disconnection of terminals 49a and 49b, switch 50 includes terminal 50a, 50b, 50c, and 50d, and is configured to switch between (i) connection of terminals 50a and 50c and connection of terminals 50b and 50d and (ii) connection of terminals 50a and 50d and connection of terminal 50b and 50c, terminal 50c is connected to terminal 40a, terminal 50d is connected to terminal 49a, terminal 40b is connected to filter 37C, terminal 40c is connected to filter 39C, terminal 40d is connected to filter 32C, terminal 40e is connected to filters 31D, 34C, and 34D, and terminal 49b is connected to filters 35C and 35D.

According to this, a filter for Band B41 is divided into filter 31D for transmission and filter 32D for reception, filters 31D, 34C, and 34D for transmission are connected to one terminal 40e, and filters 32D, 35C, and 35D for reception are connected to one terminal 49b, and thus the number of terminals of switch 40C can be reduced. Accordingly, signal transfer loss in switch 40C can be reduced.

Radio frequency circuit 1F according to Example 6 includes: power amplifiers 11 and 12; low-noise amplifier 22; switches 42 and 40; filter 31B having a passband that includes at least a portion of a first band; filter 32B having a passband that includes at least a portion of a second band; filter 34B having a passband that includes a third band for TDD; and filter 35B having a passband that includes the third band for TDD. A frequency obtained by subtracting a frequency of one signal from a sum of frequencies of two signals overlaps the third band, the two signals being randomly selected from among two signals having different frequencies in the second band and a signal having a frequency in the first band, the one signal being a remaining signal, filter 31B is connected between power amplifier 11 and switch 40, power amplifier 12 is connected to switch 42, filter 32B is connected between switch 42 and switch 40, filter 34B is connected between switch 42 and switch 40, and filter 35B is connected between low-noise amplifier 22 and switch 40.

According to this, even in a case in which triple beat distortion occurs in power amplifier 11 and/or power amplifier 12 in simultaneous transmission of one transmission signal in the first band and two transmission signals in the second band, (1) the output ends of power amplifiers 11 and 12 and the input end of low-noise amplifier 22 are not directly connected by switches, (2) the primary distortion component generated in power amplifier 11 is sufficiently attenuated by filter 31B, and (3) the primary distortion component generated in power amplifier 12 is sufficiently attenuated by filter 32B. Accordingly, high isolation can be ensured between low-noise amplifier 22 and power amplifiers 11 and 12, and thus deterioration of reception sensitivity in a case in which three transmission signals in two bands are simultaneously transferred can be reduced.

For example, in radio frequency circuit 1F according to Example 6, the first band is an FDD band, the second band is an FDD band,

the passband of filter 31B includes an uplink operating band of the first band, the passband of filter 32B includes an uplink operating band of the second band, radio frequency circuit 1F further includes: filter 33B having a passband that includes a downlink operating band of the second band; and low-noise amplifier 23, and filter 33B is connected between low-noise amplifier 23 and switch 40.

According to this, even in a case in which triple beat distortion occurs in power amplifier 11 and/or power amplifier 12 in simultaneous transmission of two transmission signals in the FDD band and one transmission signal in the FDD band, (1) the output ends of power amplifiers 11 and 12 and the input end of low-noise amplifier 22 are not directly connected by switches, (2) the primary distortion component generated in power amplifier 11 is sufficiently attenuated by filter 31B, and (3) the primary distortion component generated in power amplifier 12 is sufficiently attenuated by filter 32B. Accordingly, high isolation can be ensured between low-noise amplifier 22 and power amplifiers 11 and 12, and thus deterioration of reception sensitivity in a case in which three transmission signals in two bands are simultaneously transferred can be reduced.

For example, in radio frequency circuit 1F according to Example 6, the first band is in a frequency range higher than a frequency range of the second band.

According to this, for example, even in a case in which the frequency of triple beat distortion that occurs in simultaneous transmission of two signals in the first band that belongs to a high-band group and one signal in the second band that belongs to a middle band group overlaps the third band that belongs to the middle band group, deterioration of reception sensitivity can be reduced.

For example, in radio frequency circuit 1F according to Example 6, the first band is Band B1 for 4G LTE or Band n1 for 5G NR, the second band is Band B3 for 4G LTE or Band n3 for 5G NR, and the third band is Band B34 for 4G LTE or Band n34 for 5G NR.

### OTHER EMBODIMENTS

The above has described radio frequency circuits according to the present disclosure, based on the embodiments and examples, yet the radio frequency circuits according to the present disclosure are not limited to the above embodiments or examples. The present disclosure also encompasses another embodiment achieved by combining arbitrary elements in the above embodiments and examples, variations resulting from applying, to the above embodiments and examples, various modifications that may be conceived by those skilled in the art within a range that does not depart from the scope of the present disclosure, and various devices that each include the radio frequency circuit.

For example, in the circuit configurations of the radio frequency circuits according to the above embodiments and the examples, another circuit element and a line, for instance, may be provided between circuit elements and paths connecting signal paths, which are illustrated in the drawings.

In the embodiment described above, although bands for 5G NR or 4G LTE are used, in addition to or instead of 5G NR or 4G LTE, communication bands for other radio access technology may be used. For example, communication bands for Wireless Local Area Network may be used. For example, a millimeter wave band of at least 7 GHZ may be used. In this case, radio frequency circuit 1, antenna 2, and RFIC 3 are included in a millimeter-wave antenna module, and a distributed-constant filter, for example, may be used as a filter.

The following states features of the radio frequency circuits described based on the above embodiments.

<1>

A radio frequency circuit including:
a first power amplifier;
a second power amplifier;
a first low-noise amplifier;
a first switch;
a second switch;
a first filter having a passband that includes at least a portion of a first band;
a second filter having a passband that includes at least a portion of a second band;
a third filter having a passband that includes a third band for time division duplex; and
a fourth filter having a passband that includes the third band,
wherein a frequency obtained by subtracting a frequency of one signal from a sum of frequencies of two signals overlaps the third band, the two signals being randomly selected from among two signals having different frequencies in the first band and a signal having a frequency in the second band, the one signal being a remaining signal,
the first filter is connected between the first power amplifier and the second switch,
the second power amplifier is connected to the first switch,
the second filter is connected between the first switch and the second switch,
the third filter is connected between the first switch and the second switch, and
the fourth filter is connected between the first low-noise amplifier and the second switch.
   <2>

The radio frequency circuit according to <1>,
wherein the first switch includes a first terminal, a second terminal, and a third terminal,
the first terminal is connected to an output end of the second power amplifier,
the second terminal is connected to the second filter, and
the third terminal is connected to the third filter.
   <3>

The radio frequency circuit according to <2>,
wherein the first switch is configured to selectively switch connection of the first terminal between the second terminal and the third terminal.
   <4>

The radio frequency circuit according to any one of <1> to <3>,
wherein the second switch includes an antenna terminal, a first selection terminal, a second selection terminal, a third selection terminal, and a fourth selection terminal, and is configured to switch connection between the antenna terminal and at least one of the first selection terminal, the second selection terminal, the third selection terminal, or the fourth selection terminal,
the first selection terminal is connected to the first filter,
the second selection terminal is connected to the second filter,
the third selection terminal is connected to the third filter, and
the fourth selection terminal is connected to the fourth filter.
   <5>

The radio frequency circuit according to any one of <1> to <4>,
wherein the first band is a time division duplex band,
the second band is a frequency division duplex band,
the passband of the second filter includes an uplink operating band of the second band,
the radio frequency circuit further includes:
   a fifth filter having a passband that includes a downlink operating band of the second band; and
   a second low-noise amplifier, and
the fifth filter is connected between the second low-noise amplifier and the second switch.
   <6>

The radio frequency circuit according to <5>,
wherein the first band is in a frequency range higher than a frequency range of the second band.
   <7>

The radio frequency circuit according to <6>,
wherein the first band is Band B41 for 4th Generation Long Term Evolution (4G LTE) or Band n41 for 5th Generation New Radio (5G NR),
the second band is Band B3 for 4G LTE or Band n3 for 5G NR, and
the third band is Band B39 for 4G LTE or Band n39 for 5G NR.
   <8>

The radio frequency circuit according to any one of <1> to <4>,
wherein the first band is a time division duplex band,
the second band is a time division duplex band,
the passband of the second filter includes the second band,
the radio frequency circuit further includes:
   a third switch; and
   a second low-noise amplifier, and
the third switch is connected between the first switch and the second filter and between the second low-noise amplifier and the second filter.
   <9>

The radio frequency circuit according to <8>,
wherein the first band is in a frequency range higher than a frequency range of the second band.
   <10>

The radio frequency circuit according to <9>,
wherein the first band is Band B40 for 4th Generation Long Term Evolution (4G LTE) or Band n40 for 5th Generation New Radio (5G NR),
the second band is Band B39 for 4G LTE or Band n39 for 5G NR, and
the third band is Band B34 for 4G LTE or Band n34 for 5G NR.
   <11>

The radio frequency circuit according to any one of <1> to <4>,
wherein the first band is a frequency division duplex band,
the second band is a frequency division duplex band,
the passband of the first filter includes an uplink operating band of the first band,
the passband of the second filter includes an uplink operating band of the second band,
the radio frequency circuit further includes:
   a fifth filter having a passband that includes a downlink operating band of the second band; and
   a second low-noise amplifier, and
the fifth filter is connected between the second low-noise amplifier and the second switch.
   <12>

The radio frequency circuit according to <11>,
wherein the first band is in a frequency range lower than a frequency range of the second band.
   <13>

The radio frequency circuit according to <12>,
wherein the first band is Band B3 for 4th Generation Long Term Evolution (4G LTE) or Band n3 for 5th Generation New Radio (5G NR),
the second band is Band B1 for 4G LTE or Band n1 for 5G NR, and
the third band is Band B34 for 4G LTE or Band n34 for 5G NR.
   <14>

The radio frequency circuit according to any one of <1> to <13>,
wherein the third band is capable of supporting Power Class 2.
   <15>

A radio frequency circuit including:
a first power amplifier;
a second power amplifier;
a third power amplifier;
a fourth power amplifier;
a first low-noise amplifier;
a second low-noise amplifier;
a first switch;
a second switch;
a third switch;
a fourth switch;
a first filter having a passband that includes Band B40 for 4th Generation Long Term Evolution (4G LTE) or Band n40 for 5th Generation New Radio (5G NR);
a second filter having a passband that includes Band B41 for 4G LTE or Band n41 for 5G NR;
a third filter having a passband that includes an uplink operating band of Band B1 for 4G LTE or Band n1 for 5G NR;
a fourth filter having a passband that includes an uplink operating band of Band B3 for 4G LTE or Band n3 for 5G NR;
a fifth filter having a passband that includes Band B39 for 4G LTE or Band n39 for 5G NR;
a sixth filter having a passband that includes Band B34 for 4G LTE or Band n34 for 5G NR;
a seventh filter having a passband that includes Band B39 for 4G LTE or Band n39 for 5G NR; and
an eighth filter having a passband that includes Band B34 for 4G LTE or Band n34 for 5G NR,
wherein the first filter is connected between the first power amplifier and the second switch,
the second filter is connected between the second power amplifier and the second switch,
the third power amplifier is connected to the first switch,
the third filter is connected between the first switch and the second switch,
the fourth power amplifier is connected to the first switch,
the fourth filter is connected between the first switch and the second switch,
the fifth filter is connected between the first switch and the second switch,
the sixth filter is connected between the first switch and the second switch,
the seventh filter is connected between the first low-noise amplifier and the third switch,
the eighth filter is connected between the second low-noise amplifier and the third switch,
the second switch is connected between (i) the fourth switch and (ii) the first filter, the second filter, the third filter, the fourth filter, the fifth filter, and the sixth filter, and
the third switch is connected between (i) the fourth switch and (ii) the seventh filter and the eighth filter.
   <16>

The radio frequency circuit according to <15>,
wherein the second switch includes a first terminal, a second terminal, a third terminal, a fourth terminal, and a fifth terminal, and is configured to switch connection between the first terminal and at least one of the second terminal, the third terminal, the fourth terminal, or the fifth terminal,
the third switch includes a sixth terminal and a seventh terminal, and is configured to switch between connection and disconnection of the sixth terminal and the seventh terminal,
the fourth switch includes a first antenna terminal, a second antenna terminal, a first selection terminal, and a second selection terminal, and is configured to switch between (i) connection of the first antenna terminal and the first selection terminal and connection of the second antenna terminal and the second selection terminal and (ii) connection of the first antenna terminal and the second selection terminal and connection of the second antenna terminal and the first selection terminal,
the first selection terminal is connected to the first terminal,
the second selection terminal is connected to the sixth terminal,
the second terminal is connected to the first filter,
the third terminal is connected to the third filter,
the fourth terminal is connected to the fourth filter,
the fifth terminal is connected to the second filter, the fifth filter, and the sixth filter, and
the seventh terminal is connected to the seventh filter and the eighth filter.
   <17>

A radio frequency circuit including:
a first power amplifier;
a second power amplifier;
a first low-noise amplifier;
a first switch;
a second switch;
a first filter having a passband that includes at least a portion of a first band;
a second filter having a passband that includes at least a portion of a second band;
a third filter having a passband that includes a third band for time division duplex; and
a fourth filter having a passband that includes the third band,
wherein a frequency obtained by subtracting a frequency of one signal from a sum of frequencies of two signals overlaps the third band, the two signals being randomly selected from among two signals having different frequencies in the second band and a signal having a frequency in the first band, the one signal being a remaining signal,
the first filter is connected between the first power amplifier and the second switch,
the second power amplifier is connected to the first switch,
the second filter is connected between the first switch and the second switch,
the third filter is connected between the first switch and the second switch, and
the fourth filter is connected between the first low-noise amplifier and the second switch.
   <18>

The radio frequency circuit according to <17>,
wherein the first band is a frequency division duplex band,
the second band is a frequency division duplex band,
the passband of the second filter includes an uplink operating band of the second band,
the radio frequency circuit further includes:
   a fifth filter having a passband that includes a downlink operating band of the second band; and
   a second low-noise amplifier, and
the fifth filter is connected between the second low-noise amplifier and the second switch.
   <19>

The radio frequency circuit according to <18>,
wherein the first band is in a frequency range higher than a frequency range of the second band.
   <20>

The radio frequency circuit according to <19>,
wherein the first band is Band B1 for 4th Generation Long Term Evolution (4G LTE) or Band n1 for 5th Generation New Radio (5G NR),
the second band is Band B3 for 4G LTE or Band n3 for 5G NR, and
the third band is Band B34 for 4G LTE or Band n34 for 5G NR.

Although only some exemplary embodiments of the present disclosure have been described in detail above, those skilled in the art will readily appreciate that many modifications are possible in the exemplary embodiments without materially departing from the novel teachings and advantages of the present disclosure. Accordingly, all such modifications are intended to be included within the scope of the present disclosure.

### INDUSTRIAL APPLICABILITY

The present disclosure is widely applicable to communication devices such as mobile phones, as radio frequency circuits disposed in front end portions.

1. A radio frequency circuit comprising:
a first power amplifier;
a second power amplifier;
a first low-noise amplifier;
a first switch;
a second switch;
a first filter having a passband that includes at least a portion of a first band;
a second filter having a passband that includes at least a portion of a second band;
a third filter having a passband that includes a third band for time division duplex; and
a fourth filter having a passband that includes the third band,
wherein a frequency obtained by subtracting a frequency of one signal from a sum of frequencies of two signals overlaps the third band, the two signals being randomly selected from among two signals having different frequencies in the first band and a signal having a frequency in the second band, the one signal being a remaining signal,
the first filter is connected between the first power amplifier and the second switch,
the second power amplifier is connected to the first switch,
the second filter is connected between the first switch and the second switch,
the third filter is connected between the first switch and the second switch, and
the fourth filter is connected between the first low-noise amplifier and the second switch independently of the first switch.

2. The radio frequency circuit according to claim 1,
wherein the first switch includes a first terminal, a second terminal, and a third terminal,
the first terminal is connected to an output end of the second power amplifier,
the second terminal is connected to the second filter, and
the third terminal is connected to the third filter.

3. The radio frequency circuit according to claim 2,
wherein the first switch is configured to selectively switch connection of the first terminal between the second terminal and the third terminal.

4. The radio frequency circuit according to claim 1,
wherein the second switch includes an antenna terminal, a first selection terminal, a second selection terminal, a third selection terminal, and a fourth selection terminal, and is configured to switch connection between the antenna terminal and at least one of the first selection terminal, the second selection terminal, the third selection terminal, or the fourth selection terminal,
the first selection terminal is connected to the first filter,
the second selection terminal is connected to the second filter,
the third selection terminal is connected to the third filter, and
the fourth selection terminal is connected to the fourth filter.

5. The radio frequency circuit according to claim 1,
wherein the first band is a time division duplex band,
the second band is a frequency division duplex band,
the passband of the second filter includes an uplink operating band of the second band,
the radio frequency circuit further comprises:
a fifth filter having a passband that includes a downlink operating band of the second band; and
a second low-noise amplifier, and
the fifth filter is connected between the second low-noise amplifier and the second switch.

6. The radio frequency circuit according to claim 5,
wherein the first band is in a frequency range higher than a frequency range of the second band.

7. The radio frequency circuit according to claim 6,
wherein the first band is Band B41 for 4th Generation Long Term Evolution (4G LTE) or Band n41 for 5th Generation New Radio (5G NR),
the second band is Band B3 for 4G LTE or Band n3 for 5G NR, and
the third band is Band B39 for 4G LTE or Band n39 for 5G NR.

8. The radio frequency circuit according to claim 1,
wherein the first band is a time division duplex band,
the second band is a time division duplex band,
the passband of the second filter includes the second band,
the radio frequency circuit further comprises:
a third switch; and
a second low-noise amplifier, and
the third switch is connected between the first switch and the second filter and between the second low-noise amplifier and the second filter.

9. The radio frequency circuit according to claim 8,
wherein the first band is in a frequency range higher than a frequency range of the second band.

10. The radio frequency circuit according to claim 9,
wherein the first band is Band B40 for 4th Generation Long Term Evolution (4G LTE) or Band n40 for 5th Generation New Radio (5G NR),
the second band is Band B39 for 4G LTE or Band n39 for 5G NR, and
the third band is Band B34 for 4G LTE or Band n34 for 5G NR.

11. The radio frequency circuit according to claim 1,
wherein the first band is a frequency division duplex band,
the second band is a frequency division duplex band,
the passband of the first filter includes an uplink operating band of the first band,
the passband of the second filter includes an uplink operating band of the second band,
the radio frequency circuit further comprises:
a fifth filter having a passband that includes a downlink operating band of the second band; and
a second low-noise amplifier, and
the fifth filter is connected between the second low-noise amplifier and the second switch.

12. The radio frequency circuit according to claim 11,
wherein the first band is in a frequency range lower than a frequency range of the second band.

13. The radio frequency circuit according to claim 12,
wherein the first band is Band B3 for 4th Generation Long Term Evolution (4G LTE) or Band n3 for 5th Generation New Radio (5G NR),
the second band is Band B1 for 4G LTE or Band n1 for 5G NR, and
the third band is Band B34 for 4G LTE or Band n34 for 5G NR.

14. The radio frequency circuit according to claim 1,
wherein the third band is capable of supporting Power Class 2.

15. A radio frequency circuit comprising:
a first power amplifier;
a second power amplifier;
a third power amplifier;
a fourth power amplifier;
a first low-noise amplifier;
a second low-noise amplifier;
a first switch;
a second switch;
a third switch;
a fourth switch;
a first filter having a passband that includes Band B40 for 4th Generation Long Term Evolution (4G LTE) or Band n40 for 5th Generation New Radio (5G NR);
a second filter having a passband that includes Band B41 for 4G LTE or Band n41 for 5G NR;
a third filter having a passband that includes an uplink operating band of Band B1 for 4G LTE or Band n1 for 5G NR;
a fourth filter having a passband that includes an uplink operating band of Band B3 for 4G LTE or Band n3 for 5G NR;
a fifth filter having a passband that includes Band B39 for 4G LTE or Band n39 for 5G NR;
a sixth filter having a passband that includes Band B34 for 4G LTE or Band n34 for 5G NR;
a seventh filter having a passband that includes Band B39 for 4G LTE or Band n39 for 5G NR; and
an eighth filter having a passband that includes Band B34 for 4G LTE or Band n34 for 5G NR,
wherein the first filter is connected between the first power amplifier and the second switch,
the second filter is connected between the second power amplifier and the second switch,
the third power amplifier is connected to the first switch,
the third filter is connected between the first switch and the second switch,
the fourth power amplifier is connected to the first switch,
the fourth filter is connected between the first switch and the second switch,
the fifth filter is connected between the first switch and the second switch,
the sixth filter is connected between the first switch and the second switch,
the seventh filter is connected between the first low-noise amplifier and the third switch,
the eighth filter is connected between the second low-noise amplifier and the third switch,
the second switch is connected between (i) the fourth switch and (ii) at least one of the first filter, the second filter, the third filter, the fourth filter, the fifth filter, or the sixth filter, and
the third switch is connected between (i) the fourth switch and (ii) at least one of the seventh filter or the eighth filter.

16. The radio frequency circuit according to claim 15,
wherein the second switch includes a first terminal, a second terminal, a third terminal, a fourth terminal, and a fifth terminal, and is configured to switch connection between the first terminal and at least one of the second terminal, the third terminal, the fourth terminal, or the fifth terminal,
the third switch includes a sixth terminal and a seventh terminal, and is configured to switch between connection and disconnection of the sixth terminal and the seventh terminal,
the fourth switch includes a first antenna terminal, a second antenna terminal, a first selection terminal, and a second selection terminal, and is configured to switch between (i) connection of the first antenna terminal and the first selection terminal and connection of the second antenna terminal and the second selection terminal and (ii) connection of the first antenna terminal and the second selection terminal and connection of the second antenna terminal and the first selection terminal,
the first selection terminal is connected to the first terminal,
the second selection terminal is connected to the sixth terminal,
the second terminal is connected to the first filter,
the third terminal is connected to the third filter,
the fourth terminal is connected to the fourth filter,
the fifth terminal is connected to the second filter, the fifth filter, and the sixth filter, and
the seventh terminal is connected to the seventh filter and the eighth filter.

17. A radio frequency circuit comprising:
a first power amplifier;
a second power amplifier;
a first low-noise amplifier;
a first switch;
a second switch;
a first filter having a passband that includes at least a portion of a first band;
a second filter having a passband that includes at least a portion of a second band;
a third filter having a passband that includes a third band for time division duplex; and
a fourth filter having a passband that includes the third band,
wherein a frequency obtained by subtracting a frequency of one signal from a sum of frequencies of two signals overlaps the third band, the two signals being randomly selected from among two signals having different frequencies in the second band and a signal having a frequency in the first band, the one signal being a remaining signal,
the first filter is connected between the first power amplifier and the second switch,
the second power amplifier is connected to the first switch,
the second filter is connected between the first switch and the second switch,
the third filter is connected between the first switch and the second switch, and
the fourth filter is connected between the first low-noise amplifier and the second switch independently of the first switch.

18. The radio frequency circuit according to claim 17,
wherein the first band is a frequency division duplex band,
the second band is a frequency division duplex band,
the passband of the second filter includes an uplink operating band of the second band,
the radio frequency circuit further comprises:
a fifth filter having a passband that includes a downlink operating band of the second band; and
a second low-noise amplifier, and
the fifth filter is connected between the second low-noise amplifier and the second switch.

19. The radio frequency circuit according to claim 18,
wherein the first band is in a frequency range higher than a frequency range of the second band.

20. The radio frequency circuit according to claim 19,
wherein the first band is Band B1 for 4th Generation Long Term Evolution (4G LTE) or Band n1 for 5th Generation New Radio (5G NR),
the second band is Band B3 for 4G LTE or Band n3 for 5G NR, and
the third band is Band B34 for 4G LTE or Band n34 for 5G NR.
